(19) United States
(12) Patent Application Publication
(10) Pub. No.: US 2008/0201135 A1
(43) Pub. Date: Aug. 21, 2008

(54) Spoken Dialog System and Method

(75) Inventor: Takehide Yano, Yokohama-shi (JP)

Correspondence Address: Charles N. J. Ruggiero;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 11/857,028

(22) Filed: Sep. 18, 2007

(30) Foreign Application Priority Data
Feb. 20, 2007 (JP) 2007-039958

(51) Int. Cl. G10L 19/00; G10L 15/00

(52) U.S. Cl. 704/201; 704/231; 704/E15.001

(57) ABSTRACT

A spoken dialog system stores a history of dialog states in a memory, outputs a system response in a current dialog state, inputs a user utterance, performs speech recognition of the user utterance, to obtain one or a plurality of recognition candidates of the user utterance and likelihoods thereof with respect to the user utterance, calculates a degree of state conformance of each of the current and the preceding dialog states stored in the memory with respect to the user utterance, selects one of the current and the preceding dialog states and one of the recognition candidates based on a combination of the degree of state conformance of each dialog state and the likelihood of each recognition candidate, and performs transition from the current dialog state to a new dialog state based on dialog state selected and recognition candidate selected.

### CROSS-REFERENCE TO RELATED APPLICATIONS

This application is based upon and claims the benefit of priority from prior Japanese Patent Application No. 2007-039958, filed Feb. 20, 2007, the entire contents of which are incorporated herein by reference.

### BACKGROUND OF THE INVENTION

1. Field of the Invention

The present invention relates to a spoken dialog system which receives a user utterance and returns a response.

2. Description of the Related Art

Recently, there have been extensive studies on interfaces which allow speech or natural language input. In addition, many expert systems and the like which use such interfaces have been developed. Systems which accept input speech, input text, and the like are commercially available.

When performing natural language input, the user rarely inputs all conditions required by a system at once, and it is necessary for the user to interact with the system. If, for example, there is something inadequate about the contents of input by the user, the system needs to, for example, inquire from the user of the insufficient conditions and integrate user answers to the inquiries. In order to perform such processing, it is indispensable to use a user/system dialog processing technique.

A spoken dialog system determines the contents of interaction with the user by referring to information (dialog state information) indicating a dialog state. A dialog state is the progress of a dialog with the user. Dialog state information is information indicating the progress of a dialog with the user, which includes, for example, information obtained by integrating the contents input by the user during the dialog and information which the system has presented to the user. The spoken dialog system determines response contents by referring to this dialog state information and applying an operation determination rule. The spoken dialog system updates the dialog state information upon receiving a user input, and determines response contents to the user by referring to the updated dialog state information. The system then presents the response to the user and sequentially updates the dialog state information in accordance with the response contents.

In a spoken dialog system using speech for an input method, a recognition error may occur in input speech. Further, even if speech recognition properly operates, an error may occur in the subsequent interpretation (e.g., anaphora/supplementation processing). If the spoken dialog system is notified of a wrong input, the system presents a false response to the user and updates the dialog state information with false contents. Such an error may affect the subsequent operation of the spoken dialog system. The spoken dialog system must therefore accept an input for correction (correction input) by the user.

When the user notices an error upon receiving a false system response, he/she performs input operation for correction. This correction input can be regarded as re-input operation for past dialog state information free from the influence of the error. In order to process the correction input, therefore, it is necessary to estimate likely input contents from the user input, update the dialog state information with the input contents, or estimate dialog state information which determines response contents (dialog state information on which the input is to act) from the dialog state information which has been updated during the dialog.

The following methods have been disclosed concerning conventional spoken dialog systems: a method of determining, on the basis of an input time threshold process, whether the current input is an input corresponding to the immediately preceding state (see, e.g., reference 1: JP-A 2004-325848 (KOKAI)) and a method of generating a speech recognition grammar for correction input and determining, when a user input matches the grammar for correction, that the input is a correction input (see, for example, reference 2: JP-A 2005-316247 (KOKAI)).

According to reference 1, however, if a user makes correction after much contemplation, the input time exceeds a threshold, and the system cannot accept the correction input. According to reference 2, if the grammar for accepting the current input has something common to the grammar for correction, it is impossible to determine whether the current input is for correction. Even if they have nothing in common, some speech recognition results contain ambiguity, and one recognition result may contain both information for the correction grammar and the current information. In such a case, it is impossible to determine whether a recognition result is for correction.

These problems are ascribed to the estimation of a dialog state from only an input time in reference 1 and to the estimation of a dialog state from only input contents in reference 2. In order to accept a correction input by the user, it is necessary to perform input interpretation by comprehensively handling both the estimation of input contents and the estimation of a dialog state on which the input acts.

As described above, it is a problem in the prior art that false interpretation of a past user input cannot be easily and accurately corrected by a subsequent user input.

### BRIEF SUMMARY OF THE INVENTION

According to embodiments of the present invention, a spoken dialog system comprises:

a memory to store a history of dialog states;

a response output unit configured to output a system response in a current dialog state;

an input unit configured to input a user utterance;

a speech recognition unit configured to perform speech recognition of the user utterance, to obtain one or a plurality of recognition candidates of the user utterance and likelihoods thereof with respect to the user utterance;

a calculation unit configured to calculate a degree of state conformance of each of the current and the preceding dialog states stored in the memory with respect to the user utterance;

a selection unit configured to select one of the current and the preceding dialog states and one of the recognition candidates based on a combination of the degree of state conformance of each dialog state and the likelihood of each recognition candidate, to obtain a selected dialog state and a selected recognition candidate; and

a transition unit configured to perform transition from the current dialog state to a new dialog state based on the selected dialog state and the selected recognition candidate.

### BRIEF DESCRIPTION OF THE SEVERAL VIEWS OF THE DRAWING

FIG. 1 is a block diagram showing an example of the arrangement of a spoken dialog system according to the first embodiment;

FIG. 2 is a flowchart for explaining the processing operation of the spoken dialog system in FIG. 1;

FIG. 3 is a view showing an example of a dialog scenario;

FIG. 4 is a view showing an example of the information of a dialog state stored in a dialog history storing unit;

FIG. 5 is a view showing an example of a dialog history stored in the dialog history storing unit;

FIG. 6 is a view showing the first dialog example between the spoken dialog system and a user;

FIG. 7 is a view showing the second dialog example between the spoken dialog system and the user;

FIG. 8 is a view for explaining the processing operation of an input interpreter;

FIG. 9 is a view showing the third dialog example between the spoken dialog system and the user;

FIG. 10 is a view for explaining the processing operation of the input interpreter;

FIG. 11 is a view showing another example of the dialog history stored in the dialog history storing unit;

FIG. 12 is a view showing another example of the dialog history stored in the dialog history storing unit;

FIG. 13 is a block diagram showing an example of the arrangement of a spoken dialog system according to the third embodiment;

FIG. 14 is a flowchart for explaining the processing operation of the spoken dialog system in FIG. 13;

FIG. 15 is a view showing an example of the information of a dialog state stored in a dialog history storing unit according to the third embodiment;

FIG. 16 is a view showing an example of a dialog history stored in the dialog history storing unit according to the third embodiment;

FIG. 17 is a view showing an example of the information of a dialog state stored in a dialog history storing unit according to the fourth embodiment;

FIG. 18 is a flowchart for explaining the processing operation of a degree of state conformance calculation unit according to the fourth embodiment;

FIG. 19 is a view showing the fourth dialog example between a spoken dialog system and a user;

FIG. 20 is a view showing an example of a dialog history stored in the dialog history storing unit according to the fourth embodiment;

FIG. 21 is a view for explaining the processing operation of an input interpreter according to the fourth embodiment;

FIG. 22 is a view showing another example of the dialog scenario;

FIG. 23 is a view showing an example of the information of a dialog state stored in a dialog history storing unit according to the fifth embodiment;

FIG. 24 is a view showing the fifth dialog example between a spoken dialog system and a user;

FIG. 25 is a view showing an example of a dialog history stored in the dialog history storing unit according to the fifth embodiment;

FIG. 26 is a view for explaining the processing operation of an input interpreter according to the fifth embodiment;

FIG. 27 is a view showing the sixth dialog example between a spoken dialog system and a user; and

FIG. 28 is a view for explaining the processing operation of the input interpreter according to the fifth embodiment.

### DETAILED DESCRIPTION OF THE INVENTION

### First Embodiment

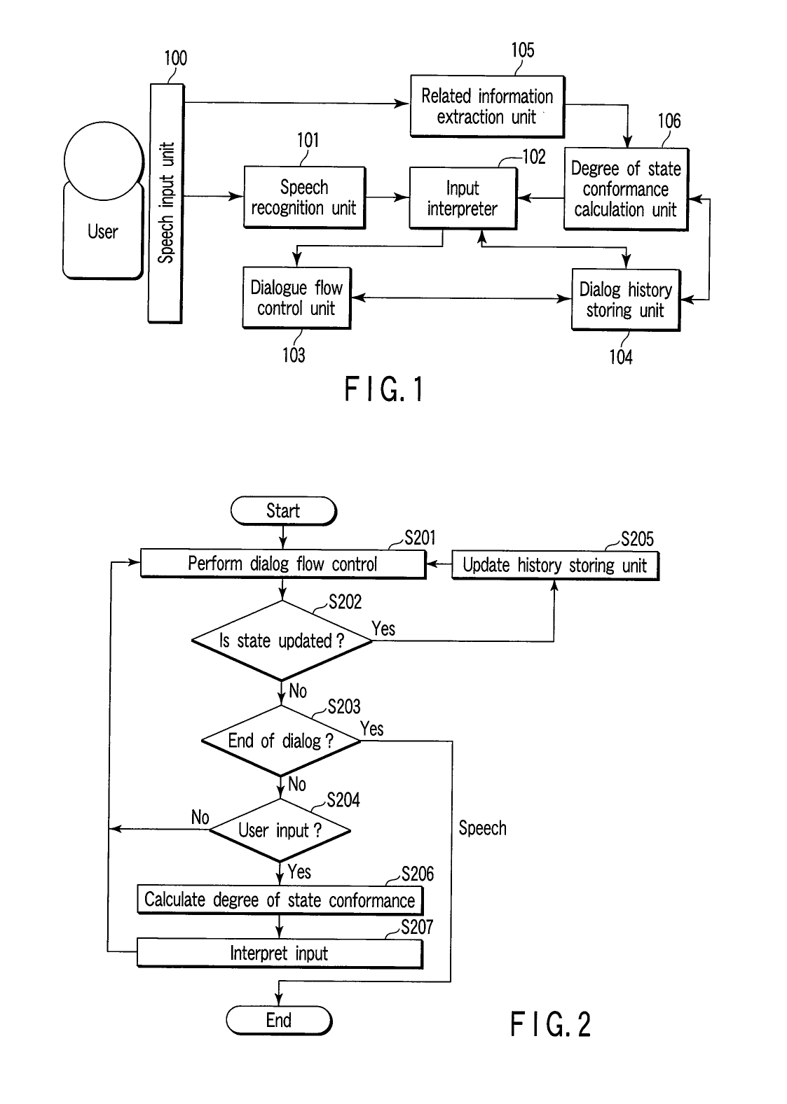

The spoken dialog system in FIG. 1 includes a speech input unit 100, speech recognition unit 101, input interpreter 102, dialog flow control unit 103, dialog history storing unit 104, related information extraction unit 105, and degree of state conformance calculation unit 106.

The speech recognition unit 101 performs speech recognition of user speech input from the speech input unit 100 including a microphone or the like. When obtaining one or a plurality of candidates (candidate character strings) as a result of speech recognition for the input speech, the speech recognition unit 101 notifies the input interpreter 102 of the speech recognition result containing the one or plurality of candidates and the scores (likelihoods) of the respective candidates with respect to the input speech. When obtaining no valid candidate having a score equal to or more than a predetermined threshold as a result of speech recognition for the input speech (when the input speech is not valid), the speech recognition unit 101 notifies the input interpreter 102 of the speech recognition result containing the corresponding information.

The input interpreter 102 interprets the user input. First of all, the input interpreter 102 generates a plurality of input candidates each including a candidate character string contained in the notified speech recognition result and a dialog state stored in the dialog history storing unit 104. The input interpreter 102 then selects one of the plurality of input candidates as an input interpretation result on the basis of the score of speech recognition for the candidate character string in each input candidate and the degree of state conformance of the dialog state in each input candidate.

The dialog flow control unit 103 refers to a dialog scenario describing a dialog flow control method and a dialog state stored in the dialog history storing unit 104, and determines and outputs a system response (to be sometimes simply referred to as a response hereinafter) corresponding to the contents of the user input on the basis of the input interpretation result notified from the input interpreter 102, thereby controlling a dialog flow with the user. The dialog flow control unit 103 presents the response to the user in the form of a speech signal, text display/image output, or the like.

The input interpretation result notified from the input interpreter 102 contains a candidate character string indicating the user input and a dialog state on which the user input acts. Upon receiving the input interpretation result, the dialog flow control unit 103 transits to the dialog state designated by the input interpretation result, and performs operation in a case wherein the user input designated by the input interpretation result is applied to the dialog state.

As dialog flow control methods, various methods are conceivable: a method of referring to a dialog scenario describing a dialog flow condition in a state transition chart and making the state transition in accordance with a user input and a method of comparing a dialog state as an information group acquired from the user with a predetermined information group which should be acquired from a user and inquiring from the user of insufficient information. The present invention can use an arbitrary one of these methods.

The dialog history storing unit 104 stores a history of dialog states indicating the condition of a dialog flow with the user. The dialog history storing unit 104 stores the current (latest) dialog state, a dialog state immediately preceding the current dialog state, and a plurality of dialog states preceding it. It suffices to erase other dialog states. The dialog history storing unit 104 will be described in detail later.

The related information extraction unit 105 extracts input related information other than the speech recognition result from the user input, and notifies the degree of state conformance calculation unit 106 of the information. Input associated information may be nonverbal information contained in a speech input, e.g., input timing information and information concerning the amplitude (power) of speech uttered by the user. The related information extraction unit 105 will be described in detail later.

The degree of state conformance calculation unit 106 calculates a degree of state conformance with respect to each dialog state stored in the dialog history storing unit 104 on the basis of the input associated information notified from the related information extraction unit 105. The degree of state conformance of a given dialog state is a value indicating the degree of conformance of a user input with respect to the dialog state. If the user input contains a strong intention of correction, the degree of state conformance with respect to the latest dialog state which is calculated by the degree of state conformance calculation unit 106 is low, and the degree of state conformance with respect to a past dialog state is high. In contrast to this, if the user input contains no intention of correction, the degree of state conformance with respect to the latest dialog state which is calculated by the degree of state conformance calculation unit 106 is high, and the degree of state conformance with respect to a past dialog state is low. The operation of the degree of state conformance calculation unit 106 will be described in detail later.

The operation of the spoken dialog system will be described next with reference to the flowchart shown in FIG. 2.

The spoken dialog system in FIG. 1 is designed to have a dialog with a user. The time when the system starts having a dialog with the user corresponds to “Start”, and the time when the system finishes having the dialog with the user corresponds to “End”.

When the system starts having a dialog with the user, the dialog flow control unit 103 controls a dialog flow with the user by referring to a dialog scenario (step S201). A state wherein the dialog flow control unit 103 outputs a system response and waits for a user input during a dialog flow can be regarded as a state wherein the dialog flow control unit 103 temporarily stops until the reception of a user input in step S201. In this case, accepting a user input, a timer event, or the like will continue the processing in step S201. The dialog flow control unit 103 checks in each step during a dialog with the user whether a dialog state is updated (step S202), whether a dialog with the user finishes (step S203), and whether any user input is received (step S204).

Assume that in step S201, the dialog flow control unit 103 determines to output a response generated in a given dialog state. In this case, in step S202, the dialog flow control unit 103 determines to update the dialog state. The process then advances to step S205. In step S205, the dialog flow control unit 103 stores this dialog state as the current dialog state in the dialog history storing unit 104. When the dialog flow control unit 103 shows the current dialog state to the user by outputting a response, the user makes some reaction to the shown dialog state, and the dialog flow control unit 103 receives user speech. Since the user input may have an effect on the dialog state at the time of the output of the response, it is preferable to cause the dialog history storing unit 104 to store the dialog state.

Upon detecting the end of the dialog in step S203, the system terminates the processing.

Upon detecting a user input (user utterance) in step S204, the system interprets the contents of the user utterance. First of all, the degree of state conformance calculation unit 106 calculates the degrees of conformance of the current dialog state and the preceding dialog state stored in the dialog history storing unit 104 with respect to the user input (step S206). The input interpreter 102 interprets the user input by referring to the calculated degree of conformance and the speech recognition result notified from the speech recognition unit 101 (step S207). Upon receiving the input interpretation result obtained by the input interpreter 102, the dialog flow control unit 103 continues a dialog with the user (step S201). The processing operations in steps S206 and S207 will be described in detail later.

The dialog flow control unit 103 will be described below. Although the dialog flow control unit 103 may use an arbitrary dialog flow control method, a method of describing a dialog scenario in a state transition chart will be exemplified as a dialog flow control method.

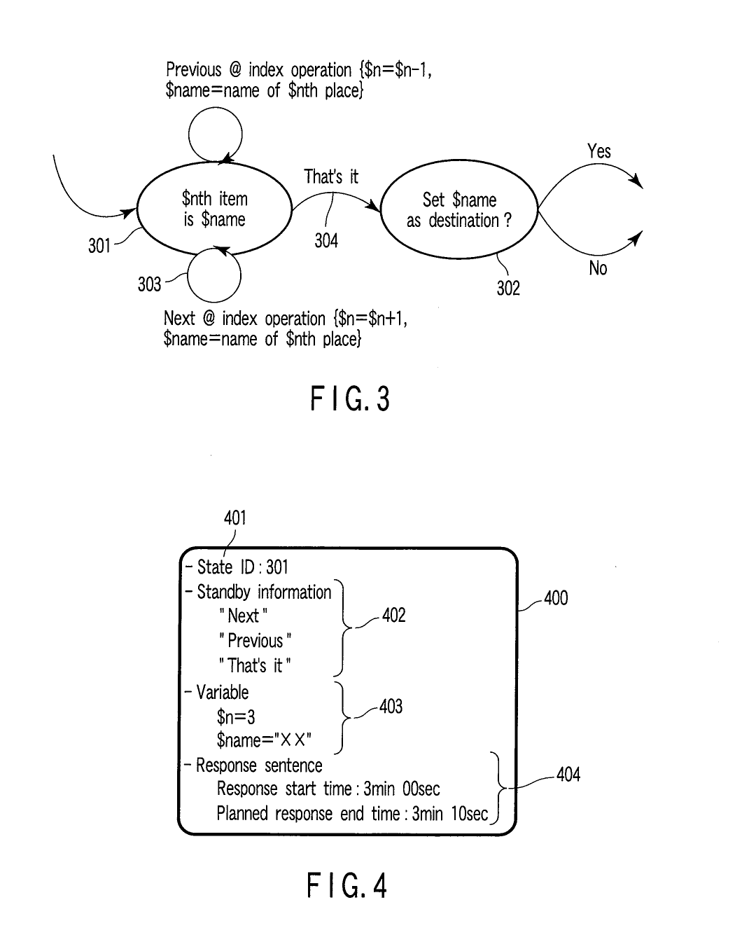

FIG. 3 shows part of the dialog scenario for searching for a place and setting a destination. The dialog scenario in FIG. 3 is described in the form of a state transition chart, in which a dialog flow condition is expressed by nodes, and each transition destination is expressed by a link. Such a node will be referred to as a “scenario node” hereinafter. A scenario node corresponds to a dialog state.

The dialog scenario in FIG. 3 shows a scenario node 301 which sequentially presents the user places as search results and a scenario node 302 which confirms whether to set the place designated by the user input (user utterance) “that's it” as a destination. A user input is associated with link connecting scenario nodes. The dialog flow control unit 103 manages, at each time point during a dialog with the user, whether the current dialog corresponds to a certain scenario node. Upon receiving a user input associated with a link extending from the current scenario node, the dialog flow control unit 103 transitions to the scenario node at the tip of the link, and sets the scenario node after the transition as the current scenario node.

At the time of transition, the dialog flow control unit 103 executes operation corresponding the contents enclosed by “{ }” and presents the user with the response described in the scenario node after transition. When transition is made to the final scenario node in the state transition chart, the dialog flow control unit 103 finishes the dialog with the user. Referring to FIG. 3, “$x” represents a variable x. If no operation designation is made to correspond to a link like a link 304, the description of operation designation in “{ }” is omitted.

The input interpreter 102 sometimes adds semantic information (to be referred to as a “semantic tag” hereinafter) such as part-of-speech information or meaning/intention to the linguistic expression of a user input. A semantic tag is effective as information for discriminating a plurality of operations if they correspond to the same expression, and it is possible to designate an operation in consideration of a semantic tag in a dialog scenario. Referring to FIG. 3, a semantic tag is described as “@XX”. At a link 303, “next @Index operation” means the user input “next” which indicates “Index operation”. For the sake of simple description, if a link from a scenario node can be uniquely determined by a linguistic expression (e.g., “next”), a semantic tag is omitted.

If, for example, the user input “next” is input when the current scenario node is the node 301, the dialog flow control unit 103 sets the node 301 at the tip of the link 303 as a scenario node to which transition is to be made next. If the variable “n” is “2” before transition, the dialog flow control unit 103 updates the variable “n” from “2” to “3”, and updates the variable “name” to the third place name (e.g., “xx”). Since the link 303 enters the scenario node 301, the dialog flow control unit 103 outputs the response “the third place is “xx”” in accordance with the content of the updated variable. If the user input “that's it” is input when the current scenario node is the node 301, the dialog flow control unit 103 sets the scenario node 302 at the tip of the link 304 as the next scenario node, and outputs the response “Set “xx” as a destination?”. The dialog flow control unit 103 presents the response by using speech, a text, or an image.

The dialog history storing unit 104 will be described in detail next. The dialog history storing unit 104 stores dialog states updated along with a dialog flow condition with the user in chronological order. The dialog history storing unit 104 need not store all dialog states from the start of the dialog to the current time, and stores the current (latest) dialog state and one or a plurality of dialog states before the current dialog state.

A dialog state is data containing the contents of a user input (standby information) which can be accepted at least in this dialog state, information expressing a dialog flow condition, and information for the calculation of a degree of state conformance. Since the structure of a dialog state depends on the dialog flow control method which the dialog flow control unit 103 uses, the following will exemplify a case wherein the dialog flow control unit 103 controls a dialog flow in accordance with a dialog scenario.

A dialog state 400 in FIG. 4 includes a state ID 401 for identifying the dialog state, standby information 402 of each dialog state, contents 403 of variables, and information 404 for the calculation of a degree of state conformance.

When a dialog is to be performed by referring to the dialog scenario in FIG. 3, a dialog flow condition corresponds to the scenario nodes 301 and 302. In this case, for the sake of a simple explanation, reference numerals 301 and 302 of the scenario nodes will be used as state IDs. The dialog state in FIG. 4 corresponds to the scenario node 301 in FIG. 3, and the state ID is “301”. The standby information of each dialog state corresponds to a link extending from a scenario node corresponding to the dialog state. This embodiment uses a response start time and a planned response end time as the information 404 for the calculation of a degree of state conformance. Such information is used to calculate a degree of state conformance from the timing of a user input. A response start time is the start time when the dialog flow control unit 103 outputs a response. A planned response end time is the time obtained by calculating the time required for the dialog flow control unit 103 to output the entire response and adding the calculated time to the response start time.

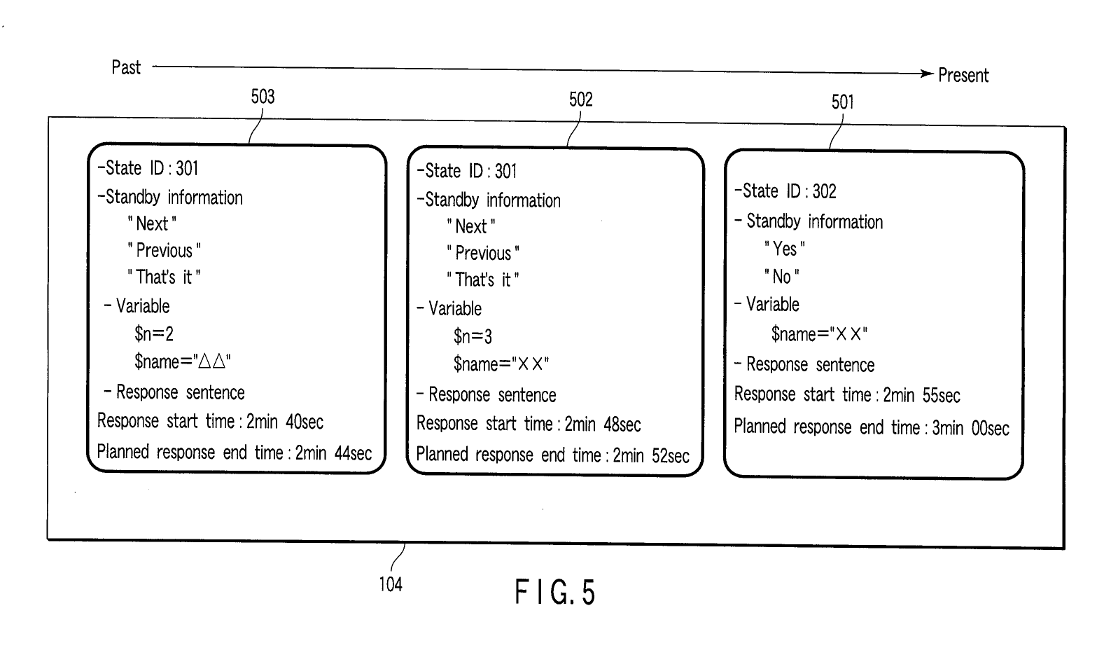

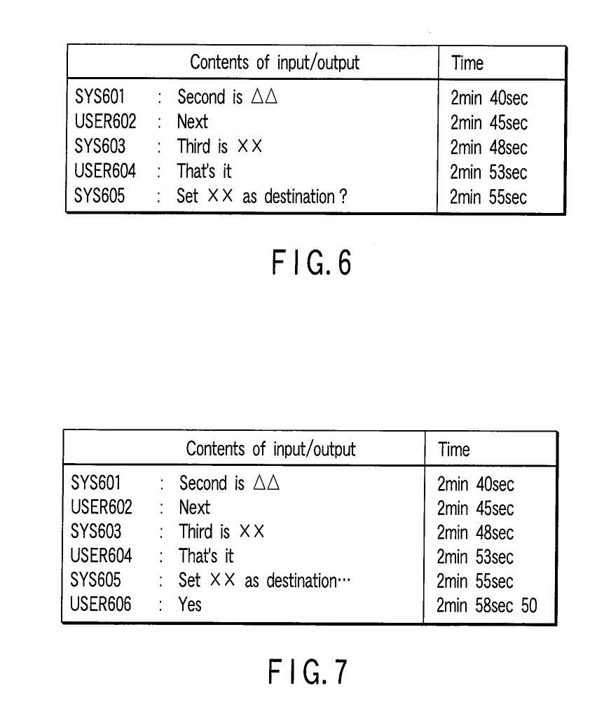

FIG. 5 shows a history of dialog states stored in the dialog history storing unit 104 after a dialog like that shown in FIG. 6 between the spoken dialog system and the user. FIG. 5 shows dialog states during a dialog with the user, which are stored in the dialog history storing unit 104, in chronological order from the left end, with a dialog state 501 at the right end corresponding to the current dialog state.

The dialog example in FIG. 6 starts from the scenario node 301 (variable n=2 and variable name=ΔΔ) in the dialog scenario in FIG. 3. Upon determining in step S201 in FIG. 2 to output the response “SYS601”, the dialog flow control unit 103 determines in step S202 to update the dialog state. In step S205, the dialog flow control unit 103 stores a dialog state 503 at this time point in the dialog history storing unit 104. Subsequently, upon determining to sequentially output the responses “SYS603” and “SYS605”, the dialog flow control unit 103 stores a dialog state 502 and the dialog state 501 in the dialog history storing unit 104 in the order named.

The operations of the related information extraction unit 105 and degree of state conformance calculation unit 106 in step S206 in FIG. 2 will be described in detail next.

This embodiment uses a user input start time as input associated information. If the immediately preceding user input has not been erroneously accepted, since a response to the input is the one that the user desires, the user accepts the response presented by the dialog flow control unit 103. If the immediately preceding user input has erroneously been accepted, a response to the input is the one that the user does not desire. In this case, therefore, when the user notices the error, he/she may perform a correction input operation. In this case, the user does not approve of transition to the current dialog state which presents a response, and performs an input operation intended to input for a preceding dialog state. Alternatively, when the user performs an input operation at the same time as the start of a response from the dialog flow control unit 103, the user does not approve of the current response, and may perform an input operation intended to effect a dialog state preceding the current dialog state. If, therefore, the time from the instant the spoken dialog system starts outputting a response to the instant the user starts inputting is short, the dialog flow control unit 103 can determine that the user intends to input for a dialog state preceding the current dialog state. The time from the instant the spoken dialog system starts outputting a response to the instant the user starts inputting will be referred to as a “response output time”.

The related information extraction unit 105 acquires an input start time at the time of user input. The related information extraction unit 105 notifies the degree of state conformance calculation unit 106 of the acquired input start time.

The degree of state conformance calculation unit 106 calculates a degree of state conformance SD with respect to each dialog state stored in the dialog history storing unit 104. In this embodiment, the degree of state conformance calculation unit 106 calculates a current degree of state conformance SD(0) and a degree of state conformance SD(1) with respect to the immediately preceding dialog state. The expression “SD(n)” represents a degree of state conformance with respect to a dialog state n dialog states preceding the current dialog states. As described above, when the response output time is short, it can be regarded that the user does not approve of transition to the current dialog state. If, therefore, the response output time is short, it can be estimated that the degree of state conformance SD(0) with respect to the current dialog state is low, and the degree of state conformance SD(1) with respect to the immediately preceding dialog state is high. This embodiment calculates a degree of state conformance on the basis of the ratio between the planned response time required to output the entire current response and the actual response output time.

In this case, the degree of state conformance calculation unit 106 calculates a response output time and a planned response time as follows:

response output time=user input start time−response start time

planned response time=planned response end time−response start time

The degree of state conformance calculation unit 106 then calculates the degree of state conformance SD(0) with respect to the current dialog state according to equation (1) given below:

SD(0)=[if response output time≦planned response time](response output time/planned response time)×100

or

=[if response output time>planned response time]100 (1)

The degree of state conformance calculation unit 106 calculates the degree of state conformation SD(1) with respect to the dialog state immediately preceding the current dialog state according to equation (2) given below:

SD(1)=100−degree of state conformance SD(0) with respect to current dialog state (2)

In step S206 in FIG. 2, the degree of state conformance calculation unit 106 calculates the degree of state conformance SD(0) of the user input with respect to the current dialog state and the degree of state conformation SD(1) of the user input with respect to the dialog state immediately preceding the current dialog state, and notifies the input interpreter 102 of them.

The input interpretation processing by the input interpreter 102 in step S207 in FIG. 2 will be described in detail next.

The input interpreter 102 generates a plurality of combinations (input candidates) each comprising a speech recognition result candidate (character string) of user speech notified from the speech recognition unit 101 and a dialog state notified from the degree of state conformance calculation unit 106. The input interpreter 102 then selects an optimal combination from these combinations. In this embodiment, the input interpreter 102 calculates the total score of each combination by adding the score of the speech recognition result in the combination with respect to the candidate character string to the degree of state conformance obtained with respect to the dialog state in the combination. The input interpreter 102 selects a combination with the highest total score as an input interpretation result.

The combination selected as the input interpretation result is the optimal combination of the content of the user input and the dialog state on which the user input acts.

If the dialog state contained in the combination selected as the input interpretation result is a dialog state immediately preceding the current dialog state, the dialog flow control unit 103 starts a dialog by effecting the content of the user input of the speech recognition result contained in the input interpretation result on the immediately preceding dialog state. That is, the dialog flow control unit 103 determines the next dialog flow by tracing the link of the input content notified with respect to a scenario node associated with the immediately preceding dialog state.

The processing operation of the spoken dialog system in FIG. 1 will be described next in a case wherein FIG. 3 shows a dialog scenario for a restaurant search service.

### First Dialog Example

A procedure (steps S202 and S205 in FIG. 2) for storing a dialog state in the dialog history storing unit 104 will be described by using the dialog example in FIG. 6. A detailed description of the processing operation in steps S206 and S207 in FIG. 2 of calculating a degree of state conformance for a user input and interpreting the user input will be omitted.

FIG. 6 shows a dialog example in a case wherein the spoken dialog system and a user start having a dialog, and a dialog state presenting a restaurant search result is reached through several times of user input and response output. In step S201 in FIG. 2, the current scenario node shifts to the scenario node 301 (variable n=2 and variable name=ΔΔ) in the dialog scenario in FIG. 3, and the dialog flow control unit 103 determines to output the response “SYS601” at 2 min 40 sec. Determining to update the dialog state in step S202, the dialog flow control unit 103 then stores the dialog state 503 in the dialog history storing unit 104. When storing the dialog state, the dialog flow control unit 103 calculates a planned response end time and stores the dialog state 503 including the planned response end time and the response start time. The process returns to step S201 to output a response and wait for a user input.

At 2 min 45 sec, the system receives the user input “USER602”. Since the user input is received, input interpretation processing is performed through steps S204, S206, and S207. Since the user input is received after the planned response end time, interpretation is made to give priority to the input for the current dialog state by the above processing in steps S206 and S207. Assume that as a result, the input interpretation result is “input content “next” acts on dialog state 503”.

The dialog flow control unit 103 receives this input interpretation result and determines to transit to the scenario node 301 (variable n=3 and variable name=XX) associated with the dialog state 503 by making transition of the link 303 extending from the scenario node 301. Along with transition to the scenario node, the dialog flow control unit 103 determines to output the response “SYS603” at 2 min 48 sec (step S201 in FIG. 2). At this time, determining to update the dialog state in step S202, the dialog flow control unit 103 stores the dialog state 502 as a dialog state newer than the dialog state 503 in the dialog history storing unit 104 in step S205. When storing the dialog state, the dialog flow control unit 103 calculates a planned response end time and stores the dialog state 502 including the planned response end time and the response start time in the dialog history storing unit 104. The process returns to step S201 to output a response and wait for a user input.

At 2 min 53 sec, the system receives the user input “USER604”. With regard to this input, as in the processing for “USER602”, the input interpretation result “input content “that's it” acts on dialog state 502” is obtained.

Upon receiving this input interpretation result, the dialog flow control unit 103 determines to transit to the scenario node 302 (variable name=XX) by making transition of the link 304 extending from the scenario node 301 associated with the dialog state 502. Along with transition of the scenario node, the dialog flow control unit 103 determines to output the response “SYS605” at 2 min 55 sec (step S201 in FIG. 2). At this time, upon determining to update the dialog state in step S202, the dialog flow control unit 103 stores the dialog state 501 as the latest dialog state in the dialog history storing unit 104 in step S205. When storing the dialog state, the dialog flow control unit 103 calculates a planned response end time, and stores the dialog state 501 including the planned response end time and the response start time (2 min 55 sec) in the dialog history storing unit 104. As a result of the above processing, the dialog history storing unit 104 stores a dialog state history like that shown in FIG. 5.

### Second Dialog Example

The operations of the input interpreter 102 and degree of state conformance calculation unit 106 will be described next by using the dialog example in FIG. 7. The dialog example in FIG. 7 is a dialog example for determining the place “XX” as a destination by adding “SYS606” to the dialog from “SYS601” to “SYS605” in FIG. 6.

The processing operation from “SYS601” to “SYS605” is the same as the dialog example shown in FIG. 6. Therefore, at the time of the output of “SYS605”, the dialog history storing unit 104 has stored a dialog state history like that shown in FIG. 5. The processing operation for the user input “USER606” will be described below. Note that “ . . . ” in “SYS605” indicates that a user input is received during response output (before the end of response output), and the response is interrupted.

If the user input “USER606” is received at 2 min 58 sec 50 msec during response output in step S201 in FIG. 2, and is detected in step S204 in FIG. 2, the process advances to step S206.

The speech recognition unit 101 then performs speech recognition processing for “USER606”. Assume that [“next” (1000 points) and “yes” (970 points)] including ambiguity is obtained as the speech recognition result of “USER706”. Note that each candidate (character string) of a speech recognition result and a score are described as “input content” (speech recognition score). If there are a plurality of candidates, they are enumerated and described in “[ ]”. The speech recognition unit 101 notifies the input interpreter 102 of such a speech recognition result.

In step S206, the degree of state conformance calculation unit 106 calculates a degree of state conformance. The related information extraction unit 105 extracts the user input start time “2 min 58 sec 50 msec” and notifies the degree of state conformance calculation unit 106 of it. The degree of state conformance calculation unit 106 calculates the degree of state conformance SD(0) of the user input with respect to the dialog state 501 and the degree of state conformation SD(1) of the user input with respect to the dialog state 502 immediately preceding the dialog state 501 by using equations (1) and (2). The planned response time of the current dialog state 501 is the difference between the planned response end time “3 min 00 sec” and the response start time “2 min 55 sec” of the dialog state 501, which is “5 sec”. The response output time until user input is the difference between the user input start time “2 min 58 sec 50 msec” and the response start time “2 min 55 sec”, which is “3.5 sec”. Therefore, SD(0)=3.5/5×100=70, and SD(1)=100−70=30. The degree of state conformance calculation unit 106 notifies the input interpreter 102 of the degrees of state conformance for the user input with respect to these two dialog states.

In step S207, the input interpreter 102 performs input interpretation processing. The input interpreter 102 generates a plurality of combinations (input candidates) each comprising one candidate of a notified speech recognition result and one dialog state notified as a degree of state conformance calculation result, and calculates the total score of each combination.

Assume that the input content candidates obtained as speech recognition results are two types of candidates, i.e., “next” and “yes”, and dialog state candidates on which the input contents act are two types of dialog states, i.e., the dialog states 501 and 502. In this case, the input interpreter 102 generates four types of input candidates, i.e., ““next” acts on dialog state 501”, ““yes” acts on dialog state 501”, ““next” acts on dialog state 502”, and ““yes” acts on dialog state 502”.

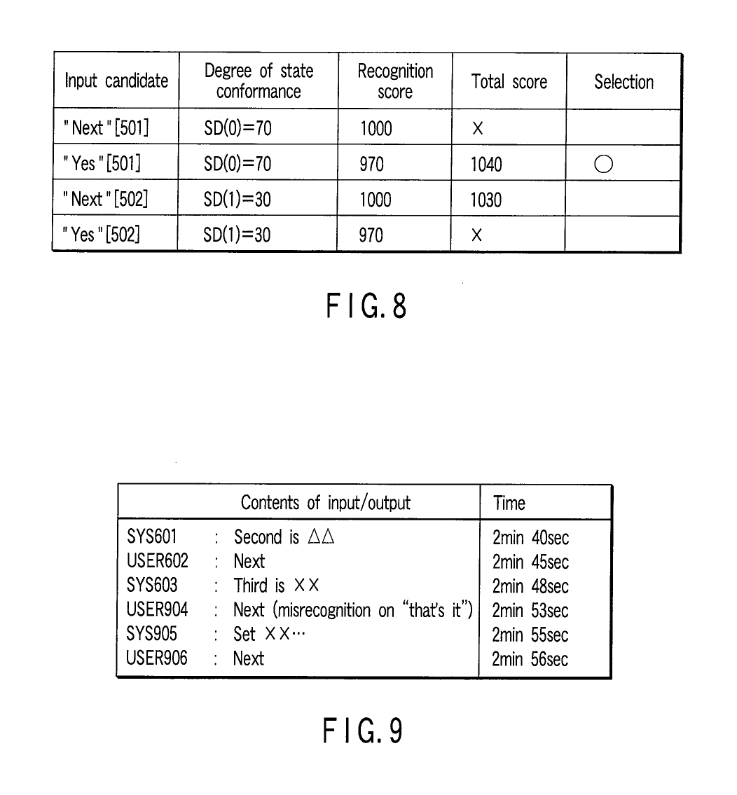

Subsequently, the input interpreter 102 calculates the total score of each input candidate. Total score calculation processing will be described in detail with reference to FIG. 8. Referring to FIG. 8, ““next”[501]” means the candidate “input content “next” acts on dialog state 501”. The total score calculated by the input interpreter 102 is the value obtained by adding the speech recognition score of each input candidate and a degree of state conformance. Note, however, that since the dialog state 501 corresponding to the scenario node 302 cannot accept the input content “next”, the combination (input candidate) of the dialog state 501 and the input content “next” is discarded. Referring to FIG. 8, with regard to the discarded input candidate, “X” is described in the total score field. The combination (input candidate) of the dialog state 502 and the input content “yes” is also discarded.

The input interpreter 102 selects an input candidate with the highest total score as an input interpretation result. In this case, “input content “yes” acts on dialog state 501” is selected as an input interpretation result. The input interpreter 102 notifies the dialog flow control unit 103 of this input interpretation result. In step S201, the dialog flow control unit 103 outputs a response indicating that the place “XX” is set as a destination.

As described above, even a given input content exhibiting a low recognition score obtained by speech recognition with respect to a user input may exhibit the highest total score when the input content is combined with a dialog state with a high degree of state conformance. When the input interpreter 102 performs input interpretation, considering a user input and the degrees of state conformance of the current dialog state and a preceding dialog state makes it possible to discard a speech recognition error candidate “next” with respect to the user input.

### Third Dialog Example

The operations of the input interpreter 102 and degree of state conformance calculation unit 106 will be described by using the dialog example in FIG. 9. The dialog from “SYS601” to “SYS603” in the dialog example in FIG. 9 is the same as that in FIG. 6. Referring to FIG. 9, the user input “next” of “USER904” is misinterpreted as “that's it”, and the response “SYS905” (the response content “Set XX as a destination?”) is output to the user. Therefore, the operation until the output of the response “SYS905” is the same as that in the dialog example in FIG. 6. At this time point, the dialog history storing unit 104 has stored a history like that shown in FIG. 5.

Although the user has expected a response with the content “the fourth item is . . . ” as a response to the user input “input USER904”, the response “SYS905” is “Set XX . . . ”. In the dialog example in FIG. 9, the user notices an error in the step of “Set XX”, and performs again the user input “USER906” which is “next” at 2 min 56 sec. As in the above description, when the dialog flow control unit 103 detects the user input “USER906” at 2 min 56 sec (step S204 in FIG. 2), the process advances to step S206.

The speech recognition unit 101 performs speech recognition processing with respect to “USER906”. In this case, assume that [“next” (1000 points), and “yes” (970 points)] including ambiguity is obtained as the speech recognition result of “USER906” as in the case of “USER606” in FIG. 7. The speech recognition unit 101 notifies the input interpreter 102 of this speech recognition result.

In step S206, the degree of state conformance calculation unit 106 calculates a degree of state conformance. The related information extraction unit 105 extracts the user input start time “2 min an 56 sec” and notifies the degree of state conformance calculation unit 106 of the time. Using equations (1) and (2), the degree of state conformance calculation unit 106 calculates the degree of state conformance SD(0) with respect to the current dialog state 501 and the degree of state conformation SD(1) with respect to the immediately preceding dialog state 502. The planned response time of the current dialog state 501 is the difference between the planned response end time “3 min 00 sec” and the response start time “2 min 55 sec” of the dialog state 501, which is “5 sec”. The response output time until user input is the difference between the user input start time “2 min 56 sec” and the response start time “2 min 55 sec”, which is “1 sec”. Therefore, SD(0)=⅕×100=20 and SD(1)=100−20=80. The degree of state conformance calculation unit 106 notifies the input interpreter 102 of the degrees of state conformance of the user input with respect to these two dialog states.

Subsequently, in step S207, the input interpreter 102 performs input interpretation processing. The input interpreter 102 generates a plurality of combinations (input candidates) each including one candidate of the notified speech recognition result and one dialog state notified as a degree of state conformance calculation result, and calculates the total score of each combination.

Assume that the input content candidates obtained as speech recognition results are two types of candidates, i.e., “next” and “yes”, and dialog state candidates on which the input contents act are two types of dialog states, i.e., the dialog states 501 and 502. In this case, the input interpreter 102 generates four types of input candidates, i.e., ““next” acts on dialog state 501”, ““yes” acts on dialog state 501”, ““next” acts on dialog state 502”, and ““yes” acts on dialog state 502”.

Subsequently, the input interpreter 102 calculates the total score of each input candidate. Total score calculation processing will be described in detail with reference to FIG. 10. The input interpreter 102 selects an input candidate with the highest total score as an input interpretation result. The input interpreter 102 discards the combination (input candidate) of the dialog state 501 and the input content “next” and the combination (input candidate) of the dialog state 502 and the input content “yes” as in the above case, and selects the candidate ““next” acts on dialog state 502” with the highest total score. The input interpreter 102 notifies the dialog flow control unit 103 of this input interpretation result. In step S201, the dialog flow control unit 103 performs operation when “next” is input in the scenario node 301 corresponding to the dialog state 502. That is, the dialog flow control unit 103 updates the variables to variable n=4 and variable name=◯◯ in accordance with the link 303, and outputs a response corresponding to the update contents to the user.

As described above, even if the user input “USER904” is misinterpreted, detecting the correction input “USER906” at an early timing when the user detects the error will increase the degree of state conformance in a past dialog state. This will increase the total score of the user input with respect to the past dialog state. In consideration of the degree of state conformance, it is possible to detect that the current user input is an input for correcting the error in the past.

According to the first embodiment described above, even if the degree of state conformance with respect to the current dialog state exceeds a given value, a speech recognition result candidate to act on a past dialog state is not discarded. If, for example, the user hears a response and inputs user speech for correction with slow timing, the degree of state conformance with respect to the past dialog state becomes “0”. If, however, an input content which can be accepted in a past dialog state is notified as a speech recognition result candidate, the past dialog state and the speech recognition result candidate to act on the dialog state can be selected.

In the first embodiment, the input interpreter 102 can comprehensively interpret a user input from a combination of a degree of state conformance which indicates the degree to which the user approves of transition to the current dialog state and a speech recognition score.

As described above, according to the first embodiment, the spoken dialog system stores a history of dialog states which transition during a dialog with a user, and calculates the degrees of state conformance of a user input with respect to the current dialog state and the immediately preceding dialog state on the basis of the input timing of user utterance, i.e., the time from the instant the system starts outputting a response to the instant the user input is received. The system selects a combination of a dialog state and a candidate character string of a speech recognition result with the highest total score (e.g., the largest sum of a speech recognition score and a degree of state conformance with respect to the user input) calculated from the speech recognition score and the degree of state conformance with respect to the user input, thereby interpreting the user input. The system then outputs a response which is obtained by causing the selected speech recognition result to act on the selected dialog state. This makes it possible to easily and accurately correct an erroneous interpretation with respect to the previous user input by a subsequent user input.

A degree of state conformance is an index for determining whether input user speech is a user input to act on the current dialog state or a user input to act on a past dialog state. In the first embodiment, the spoken dialog system calculates a degree of state conformance on the basis of the time from the instant the user hears a response to the system to the instant the user inputs user speech. More specifically, the degree of state conformance is the ratio between the predictive time (planned response time) from the instant the spoken dialog system starts outputting a response to the instant the system finishes outputting it and the time (response output) from the instant the spoken dialog system starts outputting a response to the instant the system actually detects a user input. However, the method of calculating a degree of state conformance is not limited to this. Another method of calculating a degree of state conformance will be described below.

Although a speech output has a width between the response start time and the planned response end time, when a response sentence is to be presented at once in a window, the planned response end time is made to almost coincide with the response start time. When a sentence is to be presented stepwise, the time when the entire sentence is completely presented is estimated as a planned response end time.

In the above case, when the degree of state conformance of the current dialog state is to be calculated, a planned response time is simply calculated according to planned response time=planned response end time−response start time (first calculation method for a planned response time). However, the present invention is not limited to this. Another example of the method of calculating a planned response time will be described below. Note that it is possible to use not only a planned response time calculated by one of different calculation methods but also a combination of a plurality of types of planned response times calculated by different calculation methods. For example, it is conceivable to calculate degrees of state conformance by using a plurality of types of planned response times in the above manner and add all the calculated degrees of state conformance or select the highest degree of state conformance with respect to the current dialog state.

(Second calculation method for planned response time) Planned response time=planned response end time+α−response start time (α is a positive number): In some case, the user cannot comprehend an entire response immediately after the output of the response. A degree of state conformance is the degree to which the user approves of transition to the state. Therefore, the system does not calculate the degree of state conformance as “100” at the moment when an entire response is presented but gives a margin a for the comprehension of a response to the user when he/she receives it. Although the margin a may be a constant number, the number may be increased/decreased in accordance with the amount of information to be presented.

(Third calculation method for planned response time) Planned response time=amount of information to be provided×β (β is a positive number): Assume that the spoken dialog system outputs a long response, and does not detect a user input until the lapse of a certain period of time after the start of the output of a response. In this case, it can be regarded that the user approves of transition to a state. If, however, the planned response time is longer than necessary with respect to the amount of information (e.g., the number of attributes) provided by a response, the degree of state conformance with respect to the current dialog state may decrease. For this reason, this method uses a value proportional to the amount of information to be provided as a planned response time.

(Fourth method of calculating planned response time) Planned response time=time of specific part of response+α (α is a positive number as in the second calculation method described above): When misinterpreting a user input, the spoken dialog system returns a false response. If the user can confirm that his/her input has been properly accepted, he/she may approve of transition to the current dialog state. That is, this method uses a portion for checking a user input content as a specific part of the response.

In addition to the above values, although the linear ratio between the response output time and the planned response time is simply used for a method of calculating a degree of state conformance, a high-order function or another function other than a linear function may be used. It is, however, necessary to use a monotonically increasing function so as to increase the degree of state conformance of the current dialog state with the lapse of time.

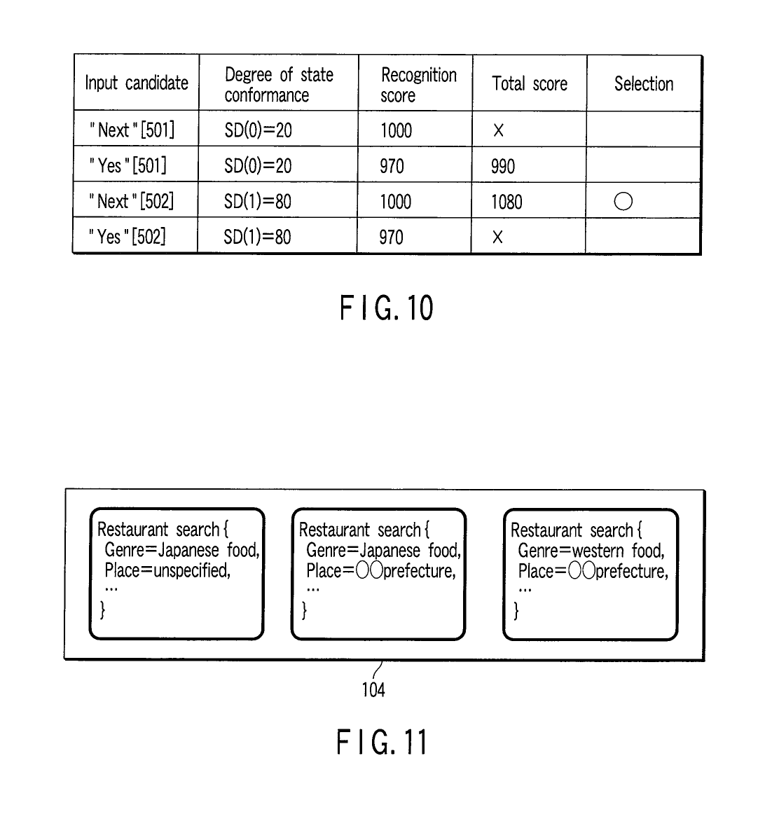

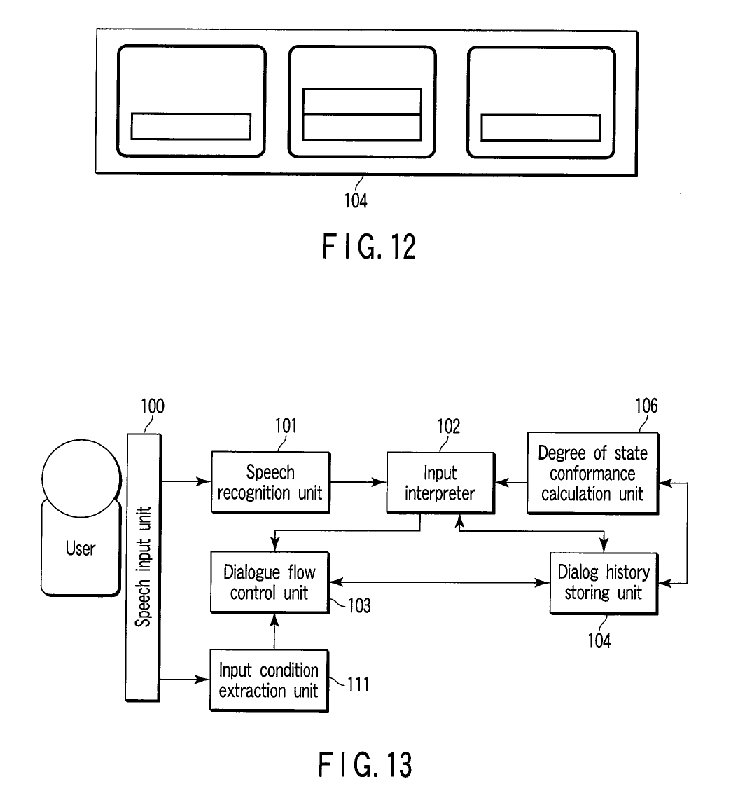

Although in the above case, the dialog flow control unit 103 uses the dialog flow control method of describing a dialog scenario in a state transition chart, it suffices to use a frame (form) format (D. Goddeau et al., “A Form-Based Dialogue Manager For Spoken Language Applications”, ICSLP'96) or a special form like a stack in “RavenClaw: Dialog Management Using Hierarchical Task Decomposition and an Expectation Agenda” (D. Bohus et al., Eurospeech 2003). In this case, the dialog history storing unit 104 stores an information acceptance state in each scene as a dialog state as shown in FIG. 11 or a stack state as a dialog state as shown in FIG. 12. In another dialog flow control method, it suffices to store a dialog flow condition in each scene as an individual dialog state in the dialog history storing unit 104.

In the above case, in step S202 in FIG. 2, the dialog history storing unit 104 stores a dialog state when the dialog flow control unit 103 outputs a response. However, the dialog history storing unit 104 may store a dialog state when it is detected that the dialog flow control unit 103 has updated a dialog state.

In the above case, the input interpreter 102 calculates a total score by adding a speech recognition score to a degree of state conformance. It suffices to add a speech recognition score and a degree of state conformance upon weighting them by constants or multiply a speech recognition score by a value which is normalized such that the maximum value of a degree of state conformance becomes “1”. In the latter case, since the influence of a degree of state conformance becomes large, a total score with importance being placed on a degree of state conformance can be obtained.

In the above case, the speech recognition unit 101 outputs a result obtained by adding a score to each candidate of a speech recognition result. However, it suffices not to add any score. In this case, all candidates can be regarded as having the same score.

In the above case, when the dialog flow control unit 103 outputs a response, the dialog history storing unit 104 stores a dialog state corresponding to the response. However, if an input interpretation result indicates an input with respect to the immediately preceding dialog state, it suffices to control a dialog flow upon deleting the current dialog state. In this case, it is possible to determine, in accordance with the height of the degree of state conformance with respect to the current dialog state, whether to erase the current dialog state. Erasing the discarded current dialog state makes it possible to suppress input interpretation to act on a dialog state discarded at the time of the next input.

### Second Embodiment

The first embodiment calculates a degree of state conformance by using information associated with the input timing of user speech. The second embodiment will exemplify a case wherein a degree of state conformance is calculated by using information other than the above input timing of user speech.

The arrangement of a spoken dialog system according to the second embodiment is the same as that shown in FIG. 1, and differs from the spoken dialog system of the first embodiment in the processing operations (the processing in step S206 in FIG. 2) of a related information extraction unit 105 and degree of state conformance calculation unit 106. When a dialog history storing unit 104 is to store each dialog state, it is not necessary to add any response start time and planned response end time (step S404 in FIG. 4).

The related information extraction unit 105 and degree of state conformance calculation unit 106 according to the second embodiment will be described below.

The related information extraction unit 105 extracts the power of the user speech of a user input (e.g., the magnitude of the amplitude of the user speech). The power of user speech is associated with the feeling of the user. If the power is high, it is estimated that the user has some uncomfortable feeling, and the interpretation of the immediately preceding input is wrong.

In step S206 in FIG. 2, the degree of state conformance calculation unit 106 calculates a degree of state conformance on the basis of the power notified from the related information extraction unit 105. As described above, if the power is high, it is likely that the current user input is a correction input for correcting the interpretation result obtained by the spoken dialog system with respect to the immediately preceding user input. If notified power P is higher than a given threshold THp, the degree of state conformance calculation unit 106 calculates a degree of state conformance such that a degree of state conformance SD(0) with respect to the current dialog state is low. The degree of state conformance calculation unit 106 calculates the degree of state conformance SD(0) according to equation (3):

SD(0)=[if power P is equal to or less than threshold THp]100

or

=[if power P is higher than threshold THp](THp×2−P)/THp×100

or

=[if SD(0) is equal to or less than “0”]0 (3)

The degree of state conformance calculation unit 106 calculates a degree of state conformation SD(1) with respect to the dialog state immediately preceding the current dialog state according to equation (4) given below:

SD(1)=100−SD(0) (4)

As described above, the second embodiment calculates a degree of state conformance by using information representing the feeling of the user at the time of the input of a user utterance, e.g., the power contained in the user input, or information which allows estimation of the feeling of the user, thereby allowing an input interpreter 102 to comprehensively determine, from a combination of a degree of state conformance and a speech recognition score, whether the user has approved of the transition of the dialog state, as in the first embodiment.

In the second embodiment, even if a degree of state conformance with respect to the current dialog state exceeds a given value, no candidate of a speech recognition result acting on a past dialog state is discarded. If an input content which can be accepted in a past dialog state is notified as a speech recognition result candidate, it is possible to select the past dialog state and the speech recognition result candidate to act on the dialog state.

In the second embodiment, the input interpreter 102 can comprehensively interpret a user input from a combination of a degree of state conformance indicating the degree to which the user approves of transmission to the current dialog state (without any anger) and a speech recognition score.

The above calculation method for degrees of state conformance uses power. However, the calculation method for degrees of state conformance is not limited to the use of power. When comparing power with the threshold, it suffices to compare the power with the threshold upon calculating the logarithm of the power. In addition, it is conceivable to use prosody or a speech rate as information which can be used to estimate the feeling of the user at the time of the input of user speech. It can be expected that the user is excited if user speech is highly intonated in terms of prosody or the user speech is high in speech rate. In such a case, a degree of state conformance is defined such that the degree of state conformance with respect to the current dialog state decreases.

### Third Embodiment

The first and second embodiments calculate a degree of state conformance from information contained in a user input. The third embodiment will exemplify a spoken dialog system which calculates a degree of state conformance by using a condition at the time of user input.

The same reference numerals as in FIG. 13 denote the same parts in FIG. 1, and a different portion will be described below. That is, the spoken dialog system in FIG. 13 includes an input condition extraction unit 111 in place of the related information extraction unit 105 in FIG. 1.

The input condition extraction unit 111 will be described. The input condition extraction unit 111 calculates a degree of condition conformance indicating whether a condition at the time of the input of user speech is suitable for the user input. User input in a condition with a low degree of condition conformance is susceptible to an error. Therefore, a degree of condition conformance can be regarded as information indicating “the possibility that the next user input is a correction input”. The input condition extraction unit 111 outputs the calculated degree of condition conformance to a dialog flow control unit 103.

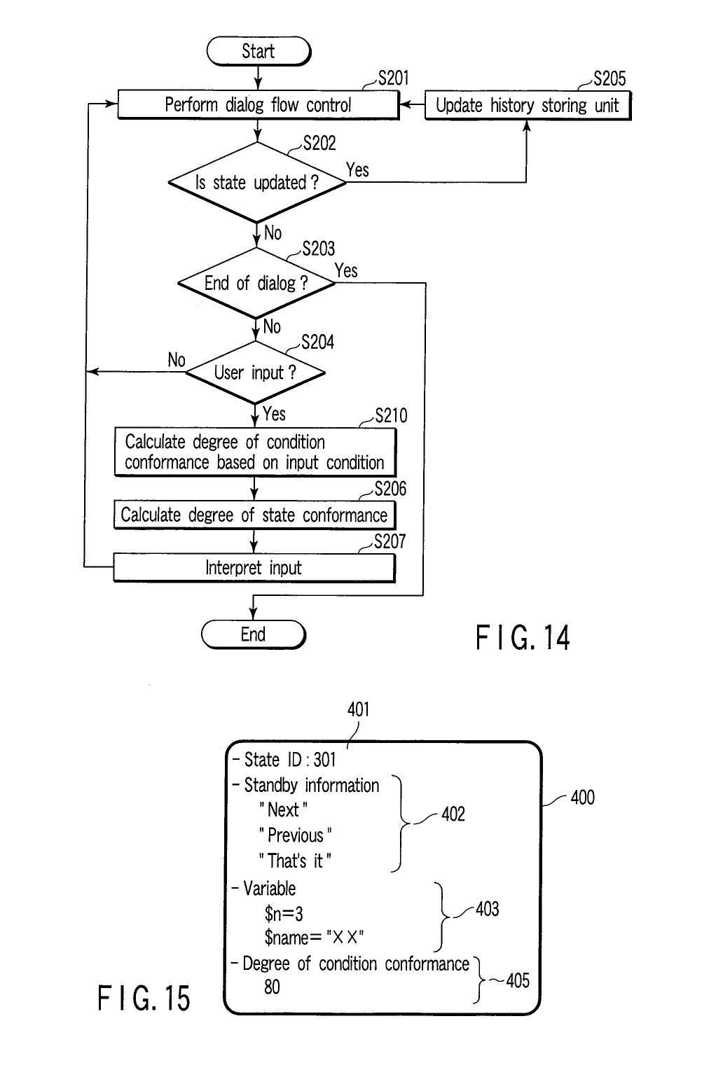

The processing operation of the spoken dialog system in FIG. 13 will be described next with reference to the flowchart shown in FIG. 14. The same reference numerals as in FIG. 14 denote the same parts in FIG. 2, and a different portion will be described below. That is, the flowchart in FIG. 14 additionally includes step S210. If the input of user speech is detected in step S204, the process advances to step S210 in which the input condition extraction unit 111 calculates a degree of condition conformance. The process then advances to step S206 to calculates a degree of state conformance. Note that the calculation method for degrees of state conformance in step S206 and information to be added to a dialog state when it is stored in a dialog history storing unit 104 are different from those in the first embodiment.

In step S210, the dialog flow control unit 103 is notified of the degree of condition conformance which is calculated by the input condition extraction unit 111, and temporarily stores the notified degree of condition conformance. Upon determining to update a dialog state (step S202) by performing dialog flow control processing (step S201) after input interpretation processing (step S207), the dialog flow control unit 103 stores the new dialog state after update as the current dialog state in the dialog history storing unit 104 (step S205). At this time, the dialog flow control unit 103 stores the temporarily stored degree of condition conformance in correspondence with the current dialog state in the dialog history storing unit 104.

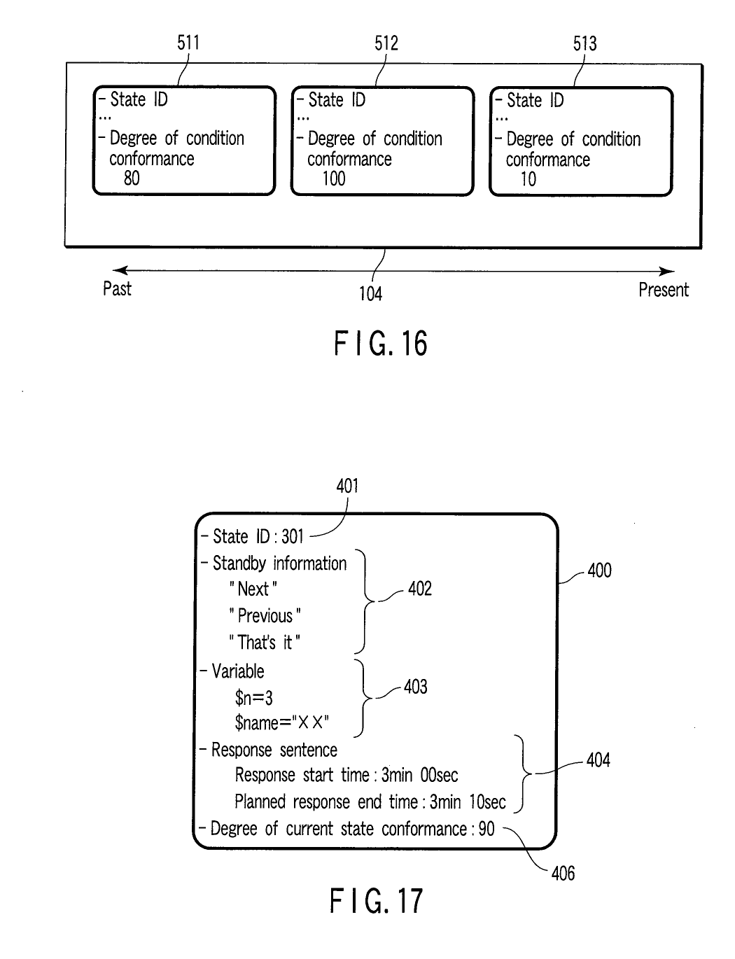

In FIG. 15, the dialog history storing unit 104 stores a dialog state including a degree of condition conformance 405 calculated by the input condition extraction unit 111 in addition to a state ID 401 indicating the dialog state/dialog flow condition, standby information 402 of each dialog state, and contents 403 of variables. The dialog history storing unit 104 stores a dialog state history to which degrees of condition conformance are added, as shown in FIG. 16. FIG. 16 shows dialog states during a dialog with the user, which are stored in the dialog history storing unit 104, in chronological order from the left end, with a dialog state 513 at the right end corresponding to the current dialog state.

The processing operation of the input condition extraction unit 111 will be described next. In this case, the power of noise at the time of the input of user speech is used as an input condition. If the power of noise at the time of the input of user speech is high, the reliability of the user input at this time point with respect to a speech recognition result deteriorates. Therefore, a degree of condition conformance is defined such that as the power of noise at the time of the input of user speech increases, the degree of condition conformance decreases. For example, it is possible to calculate a degree of condition conformance by using equation (3). In this case, a degree of state conformance SD(0) is calculated by replacing power P in equation (3) with the power of noise detected at the time of the input of user speech.

The processing operation of a degree of state conformance calculation unit 106 will be described next. The dialog history storing unit 104 stores a dialog state history to which degrees of condition conformance are added like that shown in FIG. 16. The degree of state conformance calculation unit 106 directly determines the degree of condition conformance of each dialog state stored in the dialog history storing unit 104 as a degree of state conformance. Therefore, the degree of state conformance SD(0) of the current dialog state is set as the degree of condition conformance added to the current dialog state. If, for example, the dialog history storing unit 104 has stored a dialog state history like that shown in FIG. 16, SD(0)=10 (a degree of condition conformance added to a dialog state 513), and SD(1)=100 (a degree of condition conformance added to a dialog state 512).

As described above, according to the third embodiment, a degree of condition conformance is calculated on the basis of information indicating a condition at the time of the input of user speech which influences the speech recognition result on user speech (e.g., the power of noise indicating the magnitude of noise). Using this degree of condition conformance as a degree of state conformance makes it possible for the input interpreter 102 to easily determine the content of a user input and a dialog state on which the user input is to act from a combination of the degree of state conformance and a speech recognition score, as in the first embodiment.

The third embodiment is not designed to discard a speech recognition result candidate to act on a past dialog state even if a degree of state conformance with respect to the current dialog state exceeds a given value. If an input content which can be accepted in only a past dialog state is notified as a speech recognition result candidate, the past dialog state and the speech recognition result candidate to act on the dialog state can be selected.

Note that the above calculation method for degrees of condition conformance is based on noise power, but is not limited to this. When comparing power with a threshold, it suffices to compare the power with the threshold upon calculating the logarithm of the power. In addition, as a measure indicating the validity of a user input, a speech recognition score can be used as a degree of condition conformance. When a degree of condition conformance is to be calculated by using a speech recognition score, a degree of condition conformance is defined such that its value decreases with a decrease in speech recognition score.

### Fourth Embodiment

The first to third embodiments interpret a user input by calculating degrees of state conformance with respect to the current dialog state and the immediately preceding dialog state. The fourth embodiment will exemplify a spoken dialog system which interprets a user input by calculating a degree of state conformance with respect to the dialog state two dialog states preceding the current dialog state.

An example of the arrangement of the spoken dialog system according to the fourth embodiment is the same as that shown in FIG. 1. Note that the processing operation of a degree of state conformance calculation unit 106 (the processing in step S206 in FIG. 2) and the information contained in each dialog state stored in a dialog history storing unit 104 are different from those in the first embodiment.

A dialog state 400 in FIG. 17 includes a state ID 401 indicating the dialog flow condition of the dialog state, standby information 402 of each dialog state, contents 403 of variables, and information 404 for calculating a degree of state conformance as in the first embodiment. This dialog state also includes a degree of state conformance 406 between a user input and the dialog state 400, which is calculated by the degree of state conformance calculation unit 106.

The degree of state conformance 406 is a degree of state conformance SD(0) calculated when the dialog state 400 is the current dialog state. If the current dialog state is the jth dialog state from the start of a dialog, the degree of state conformance 406 is expressed as a degree of current state conformance CSD(j). Note that if the dialog history storing unit 104 is to store the (j+1)th dialog state without calculating CSD(j), the unit stores the maximum value of a degree of state conformance (“100” in the first embodiment) as CSD(j). Such a condition occurs when a response to the jth dialog state 400 is complete, and the (j+1)th response is continuously output.

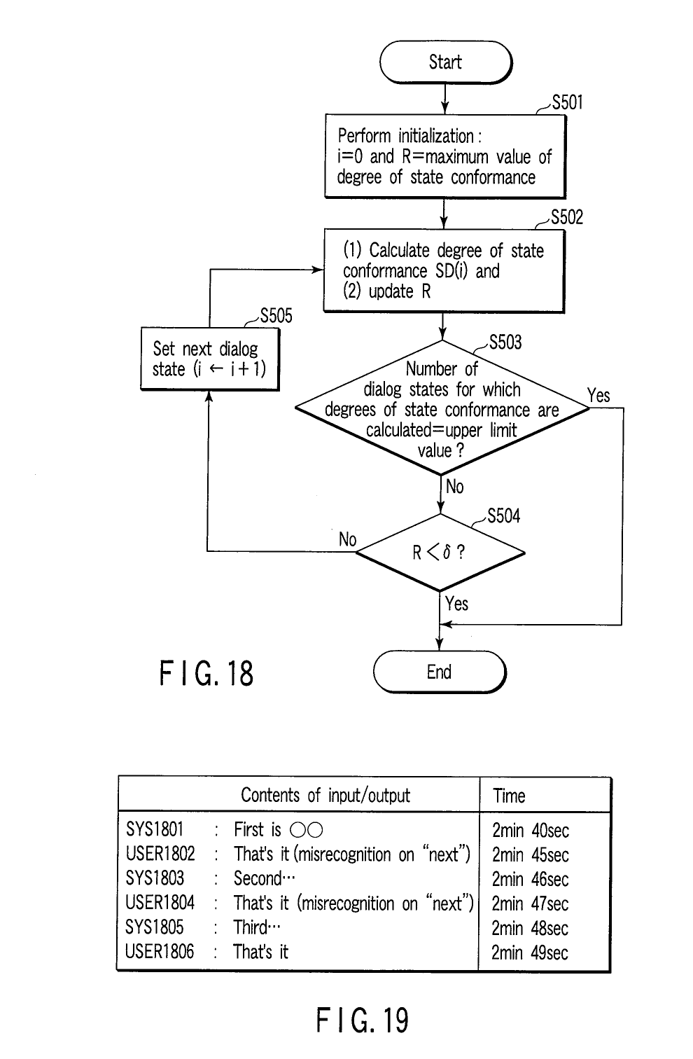

FIG. 18 shows the processing operation (step S206 in FIG. 2) of the degree of state conformance calculation unit 106. The degree of state conformance calculation unit 106 calculates degrees of state conformance by correcting each degree of current state conformance using a history of degrees of current state conformance CSD(j).

The degree of state conformance calculation unit 106 starts when a user input is detected in step S204 in FIG. 2. In step S206 in FIG. 2, the degree of state conformance calculation unit 106 executes degree of state conformance calculation processing like that shown in FIG. 10. When this processing is complete, the process advances to step S207 in FIG. 2, in which an input interpreter 102 executes input interpretation processing. Assume that the dialog history storing unit 104 stores the jth (current) dialog state from the start of a dialog as the current dialog state.

The degree of state conformance calculation unit 106 performs initialization before the calculation of a degree of state conformance (step S501). Initialization processing includes the processing of calculating the degree of state conformance SD(0) (i.e., the processing of calculating a degree of current state conformance CSD(current)) as in the first embodiment and the processing of initializing variables for the calculation of degrees of state conformance. The variables for the calculation of degrees of state conformance include an index variable i indicating by how many dialog states the dialog state stored in the dialog history storing unit 104 precedes the current dialog state, and a residue R for the allocation of degrees of state conformance. In initialization processing, i=0 and R=predetermined maximum value of degree of state conformance (e.g., “100” in this case). Note that a dialog state corresponding to i=0 is the current dialog state.

Subsequently, the degree of state conformance calculation unit 106 calculates a degree of state conformance SD(i) with respect to the (j=current−i)th dialog state (step S502). The degree of state conformance calculation unit 106 calculates the degree of state conformance SD(i) by allocating the current value of R on the basis of a degree of current state conformance CSD(current−i) of the (j=current−i)th dialog state according to equation (5) given below. After the allocation, as indicated by equation (6), the degree of state conformance calculation unit 106 updates the value of R by subtracting the value of SD(i) allocated to the (j=current−i)th dialog state from the current value of R.

SD(i)=R×CSD(current−i)/predetermined maximum value of degree of state conformance (5)

R=R−SD(i) (6)

The process then advances to step S503, in which the degree of state conformance calculation unit 106 checks whether the number of dialog states for which degrees of state conformance have been calculated is equal to a predetermined upper limit value. The number of dialog states for which degrees of state conformance are calculated is limited to the upper limit value to suppress the number of combinations of dialog states and speech recognition result candidates, which the input interpreter 102 considers. Upon determining in step S503 that the number of dialog states for which degrees of state conformance are calculated is equal to the upper limit value, the degree of state conformance calculation unit 106 terminates the processing. If the number of dialog states is less than the upper limit value, the process advances to step S504.

In step S504, the degree of state conformance calculation unit 106 checks whether the value of R after update becomes a sufficiently small value. If, for example, the value of R is smaller than a threshold δ which is set for determining that the value is sufficiently small, the degree of state conformance calculation unit 106 determines that the value of R is sufficiently small. If the degree of state conformance calculation unit 106 determines in step S504 that the value of R is sufficiently small, since the subsequent degree of state conformance SD(i) becomes a negligibly small value, the degree of state conformance calculation unit 106 stops calculating any more degree of state conformance (terminates the processing). If the degree of state conformance calculation unit 106 determines in step S504 that the value of R is equal to or more than the threshold δ, the process advances to step S505.

In step S505, i is incremented by one to calculate a degree of state conformance with respect to the next dialog state. The process then advances to step S502. Subsequently, the same processing as that described above is performed for the next dialog state.

As described above, the degree of state conformance calculation unit 106 according to the fourth embodiment calculates the degree of state conformance of each dialog state by allocating the predetermined maximum value of a degree of state conformance on the basis of the degrees of current state conformance of the current dialog state and a plurality of preceding dialog states. This calculation method suppresses the correspondence between past dialog states and user inputs. If, however, dialog states with low degrees of current state conformance (dialog states to which the user does not approve of transition) continue, this method allows to obtain a degree of state conformance such that the degree of state conformance of a preceding dialog state increases.

As an example of a method of calculating CSD(current) in step S501, it suffices to use a method of calculating SD(0) by using equation (1) as in the first embodiment.

The processing operation of the spoken dialog system according to the fourth embodiment will be described by exemplifying a dialog scenario for a restaurant search service.

### Fourth Dialog Example

The processing operation of the spoken dialog system will be described with reference to the dialog example in FIG. 19. In this dialog example, although the user has selected the first restaurant, the user input “that's it” is consecutively misinterpreted twice as “next”.

The processing operation of storing a dialog state history in the dialog history storing unit 104 through the dialog from “SYS1801” to “SYS1805” (steps S202 and S205 in FIG. 2) will be described first. In this case, a description of processing at the time of user input (steps S206 and S207 in FIG. 2) will omitted.

Assume that a dialog state presenting a restaurant search result is reached through several times of user input and response output after the start of a dialog between the spoken dialog system and the user, and a dialog flow control unit 103 performs dialog flow control processing in step S201 in FIG. 2.

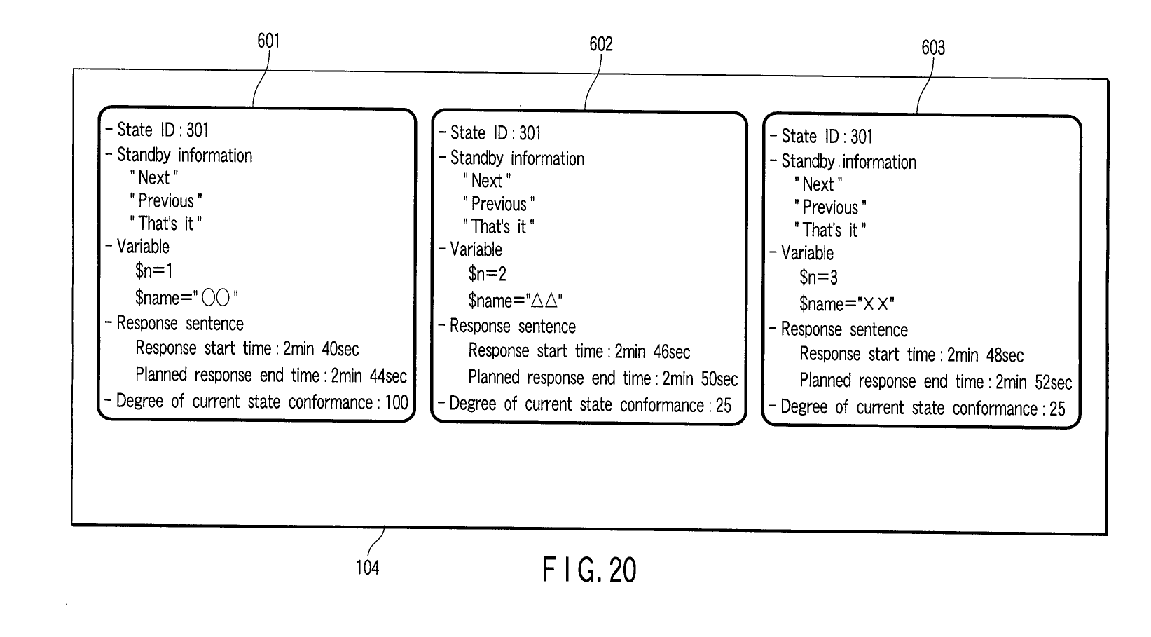

That is, the current scenario node shifts to the scenario node 301 (variable n=1 and variable name=◯◯) in the dialog scenario in FIG. 3, and the dialog flow control unit 103 determines to output the response “SYS1801” at 2 min 40 sec. Determining to update the dialog state in step S202, the dialog flow control unit 103 stores a dialog state 601 at this time in the dialog history storing unit 104, as shown in FIG. 20. When storing the dialog state, the dialog flow control unit 103 calculates a planned response end time and stores a dialog state 503 upon adding the planned response end time and the response start time to the dialog state. Note that at this stage, since the degree of current state conformance has not been calculated, the dialog state 601 is not included. The process returns to step S201 to output a response and waits for a user input.

At 2 min 45 sec, the system receives the user input “USER1802”. Since the user input is detected, the process advances from step S204 to step S206, in which the degree of state conformance calculation unit 106 calculates the degree of current state conformance. In this case, since the user input is detected after the planned response end time, when the degree of state conformance calculation unit 106 calculates the degree of state conformance SD(0) by using equation (1), the value becomes “100”. The degree of state conformance calculation unit 106 stores this value as the degree of current state conformance in the dialog history storing unit 104 within the dialog state 601. The degree of state conformance calculation unit 106 also calculates a degree of state conformance with respect to each dialog state. The process advances to step S207 to interpret the user input.

Assume that as a result of the interpretation of “USER1802”, the input interpretation result “input content “next” acts on dialog state 601” is obtained through the influence of the misrecognition of the user speech. Upon receiving this input interpretation result, the dialog flow control unit 103 determines to output the response “SYS1803” as in the first embodiment. At this time, the dialog history storing unit 104 stores a dialog state 602 as the current dialog state (steps S202 and S205 in FIG. 2). Note that the degree of current state conformance of the newly stored dialog state 602 has not been calculated, and hence has not been included in the dialog state 602. Thereafter, the process returns to step S201 to output the response “SYS1803”.

At 2 min 47 sec, the system receives the user input “USER1804”. At this time, as in the above case, the degree of state conformance calculation unit 106 calculates the degree of current state conformance of the dialog state 602 and stores it in the dialog history storing unit 104 in correspondence with the dialog state 602, and also calculates the degree of state conformance with respect to each dialog state. Subsequently, in step S207, the user input is interpreted. In this case, since the system detects the user input “USER1804” after the lapse of one sec since the start of the output of a response output having a total duration of four sec (at this time, the response output is interrupted), when SD(0) is calculated by using equation (1), the resultant value is “25”. This value is stored as the degree of current state conformance in the dialog state 602 in the dialog history storing unit 104.

Assume that as a result of the interpretation of “USER1804”, the input interpretation result ““next” acts on dialog state 602” is obtained through the influence of misrecognition of the user speech. In this case, the dialog flow control unit 103 receives this input interpretation result, and determines to output the response “SYS1805” as in the first embodiment. At this time, the dialog history storing unit 104 stores a dialog state 603 as the current dialog state (steps S202 and S205 in FIG. 2). Note that the degree of current state conformance of the newly stored dialog state 603 has not been calculated, and hence has not been included in the dialog state 603. Thereafter, the process returns to step S201 to output the response “SYS1805”.

At 2 min 49 sec, the system receives the user input “USER1806”. “USER1806” is a correction input to correct an error in the interpretation result on “USER1802” and select the first item “◯◯”. With the above processing, the dialog history storing unit 104 has stored information like that shown in FIG. 19 at the time of the input of “USER1806”. Note that the degree of current state conformance of the dialog state 603 is not stored yet.

In this case, the degree of state conformance calculation unit 106 sets the upper limit value of the number of dialog states for which degrees of state conformance are calculated to “5”, a threshold δ for the residue R to “5”, and the predetermined maximum value of a degree of state conformance to “100” as parameters used for the processing shown in FIG. 18.

Upon detecting the user input “USER1806” at 2 min 24 sec, the system calculates the degree of current state conformance of the dialog state 603, stores it in the dialog state 603 in the dialog history storing unit 104, and also calculates a degree of state conformance with respect to each dialog state in step S206. Thereafter, in step S207, the system interprets the user input.

Upon receiving a user input, a speech recognition unit 101 performs speech recognition processing for the user input “USER1806”. Assume that in this case, the speech recognition unit 101 has obtained the result ““that's it” (1000 points) and “next” (990 points)” as the speech recognition result on “USER1806”. The speech recognition unit 101 notifies the input interpreter 102 of this speech recognition result.

In step S206, the degree of state conformance calculation unit 106 calculates a degree of state conformance. The related information extraction unit 105 extracts the user input time “2 min 49 sec” and notifies the degree of state conformance calculation unit 106 of it. The processing operation of the degree of state conformance calculation unit 106 will be described in detail with reference to FIG. 18.

First of all, the degree of state conformance calculation unit 106 executes initialization processing (step S501). In step S501, the degree of state conformance calculation unit 106 calculates the degree of current state conformance of the current dialog state 603, and also sets the index variable i to “0” and the predetermined maximum value “100” of a degree of state conformance to R.

The degree of state conformance calculation unit 106 calculates the degree of current state conformance by using equation (1). Since the planned response time is four sec and the response output time is 2 sec 49 sec−2 min 48 sec=1 sec, SD(0)=¼×100=25 according to equation (1). This value is stored as the degree of current state conformance of the dialog state 603 in the dialog state 603. FIG. 20 shows the state of the dialog history storing unit 104 at this time. For the sake of simple description, the degree of current state conformance of the dialog state 603 is represented by CSD(603).

The process advances to step S502, in which the degree of state conformance calculation unit 106 calculates the degree of state conformance SD(0) with respect to the dialog state 603 by using equations (5) and (6), and updates R. That is, the degree of state conformance calculation unit 106 obtains

SD(0)R×CSD(603)/100=100× 25/100=25

R=R−SD(0)=75

The total number of dialog states for which degrees of state conformance have been calculated is one, and hence has not reached the upper limit value “5” (step S503). In addition, since the residue R is “80”, which is larger than “5” (step S504), the process advances to step S505 to increment i by one (i=1). The process then advances to step S502 to calculate the degree of state conformation SD(1) with respect to the dialog state 602 immediately preceding the dialog state 603. Note that the degree of current state conformance of the dialog state 602 is represented by CSD(602). The degree of state conformance calculation unit 106 obtains

SD(1)=R×CSD(602)/100=75× 25/100=19

(rounding off to the first decimal place)

R=R−SD(1)=75−19=56

The total number of dialog states for which degrees of state conformance have been calculated is two, and hence has not reached the upper limit value “5” (step S503). In addition, since the residue R is “64”, which is larger than “5” (step S504), the process advances to step S505 to increment i by one (i=2). The process then advances to step S502 to calculate a degree of state conformance SD(2) with respect to the dialog state 601 immediately preceding the dialog state 602. Note that the degree of current state conformance of the dialog state 601 is represented by CSD(601). The degree of state conformance calculation unit 106 obtains

SD(2)=R×CSD(601)/100=56× 100/100=56

R=R−SD(2)=0

The total number of dialog states for which degrees of state conformance have been calculated is three, and hence has not reached the upper limit value “5” (step S503). However, the residue R is “0”, which is smaller than “5” (step S504). Therefore, the system terminates the processing. The degree of state conformance calculation unit 106 notifies the input interpreter 102 of the degrees of state conformance (SD(0) to SD(2)) with respect to these three dialog states.

Subsequently, in step S207, the input interpreter 102 performs input interpretation processing. The input interpreter 102 generates a plurality of combinations (input candidates) each comprising one candidate of a notified speech recognition result and one dialog state notified as a degree of state conformance calculation result, and calculates the total score of each combination.

Assume that the input content candidates obtained as speech recognition results are two types of candidates, i.e., “that's it” and “next”, and dialog state candidates on which the input contents act are three types of dialog states, i.e., the dialog states 601, 602, and 603. In this case, the input interpreter 102 generates six types of input candidates by combining them, i.e., ““that's it” acts on dialog state 603”, ““next” acts on dialog state 603”, ““that's it” acts on dialog state 602”, ““next” acts on dialog state 602”, ““that's it” acts on dialog state 601”, and ““next” acts on dialog state 601”.

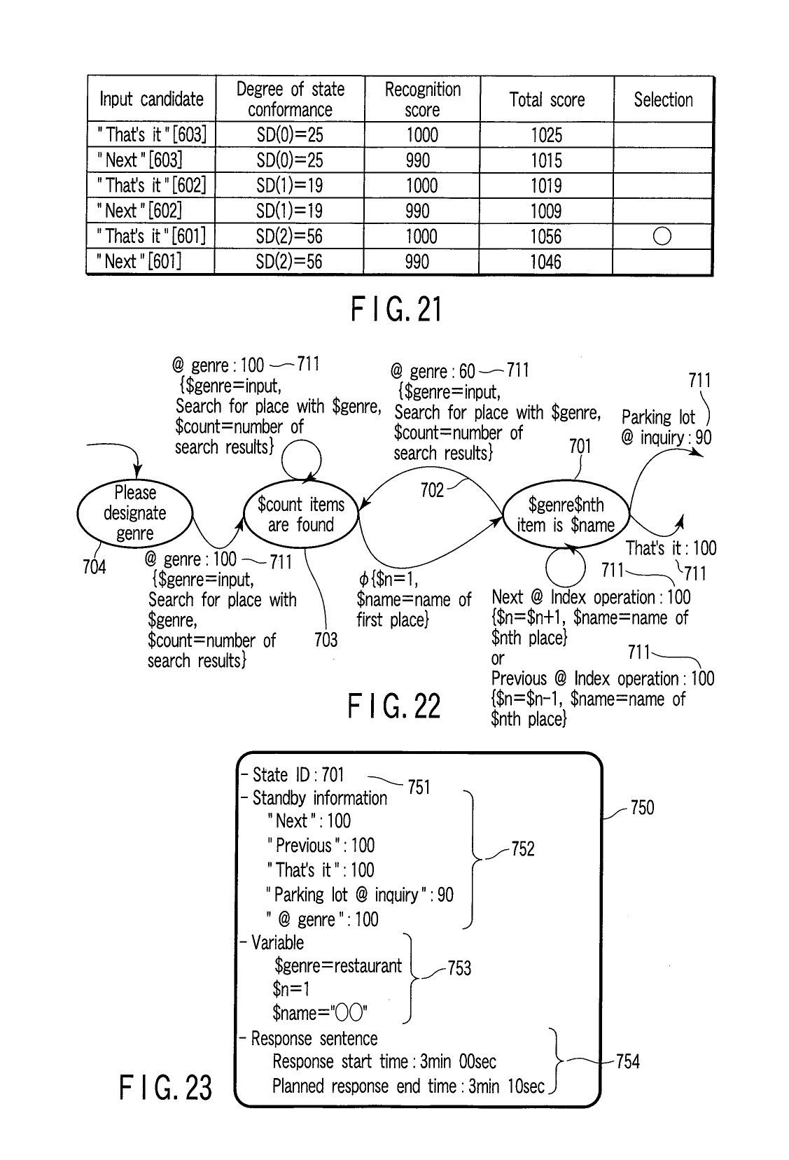

Subsequently, the input interpreter 102 calculates the total score of each input candidate. Total score calculation processing will be described in detail with reference to FIG. 21. The input interpreter 102 selects an input candidate with the highest total score as an input interpretation result. In this case, the input interpreter 102 selects the input candidate ““that's it” acts on dialog state 601”.

Note that before calculating total scores, the input interpreter 102 may delete input candidates of the above six types of input candidates, which exist in a past dialog history, such as ““next” acts on dialog state 601” and ““next” acts on dialog state 602”. This is because input candidates existing in a past dialog history repeat the same operation.

The input interpreter 102 notifies the dialog flow control unit 103 of this selected input interpretation result. The process then advances to step S201, in which the dialog flow control unit 103 returns a response indicating that the place “◯◯” is set to a destination.

In this dialog example, misrecognition occurs repeatedly, and the dialog state desired by the user two dialog states precedes the current dialog state. However, since the user performs correction input twice at the timings of detection of errors, the degrees of current state conformance of the dialog states 602 and 603 which have caused transition due to misrecognition have decreased. Since the degree of state conformance calculation unit 106 calculates the degree of state conformance of each dialog state in accordance with the degree of current state conformance of each dialog state, the degree of state conformance of a dialog state which has caused transition due to misrecognition decreases. This allows the user to correct the dialog flow as he/she desires.

As described above, according to the fourth embodiment, this system stores degrees of current state conformance together with dialog states which transition during a dialog with the user, and calculates degrees of state conformance with respect to the respective dialog states in accordance with a current dialog state history. The system then selects the content of the user speech and a dialog state to which the content of the user speech is applied on the basis of the speech recognition scores and degrees of state conformance. This makes it possible to select a dialog state on which the user input is to act by tracing back to the past. Therefore, misinterpretation of a past user input can be easily and accurately corrected by a subsequent user input.

Note that in the above case, the calculation method for a degree of current state conformance is based on the timing of a user input. However, the calculation method for a degree of current state conformance is not limited to this. A measure like the power of user speech or the power of noise can be used as a degree of current state conformance, as described in the second and third embodiments. Note that when a degree of conformance is to be calculated before user input, as in the third embodiment, this degree of conformance can be stored as a degree of current state conformance.

In addition, in the above case, the degree of state conformance of each dialog state is calculated by allocating the predetermined maximum value of a degree of state conformance on the basis of the degree of current state conformance of each dialog state. However, the present invention is not limited to this, and the degree of current state conformance of each dialog state may be used as the degree of state conformance of each dialog state without any change.

### Fifth Embodiment

The first to fourth embodiments interpret a user input by using a degree of state conformance and a speech recognition score. In contrast, the fifth embodiment will exemplify a spoken dialog system which interprets a user input by additionally using a degree of semantic conformance of the content of a user input with respect to a dialog state.

An example of the arrangement of the spoken dialog system according to the fifth embodiment is the same as that shown in FIG. 1. Note, however, that the processing operation (step S207 in FIG. 2) of an input interpreter 102 differs from that in the first embodiment. In addition, the dialog scenario to which a dialog flow control unit 103 refers and each dialog state stored in a dialog history storing unit 104 differ from those in the first embodiment.

FIG. 22 shows an example of a dialog scenario to which the dialog flow control unit 103 refers in the fifth embodiment. The dialog scenario in FIG. 22 differs from the one shown in FIG. 3 in that a degree of semantic conformance 711 with respect to the meaning of the content of a user input is added to each link in the dialog scenario in FIG. 22.

Assume that the meaning of the content of a user input is represented by a combination of a linguistic expression and a semantic tag. For example, a speech recognition unit 101 adds a semantic tag indicating the meaning of each candidate (character string) obtained as a result of speech recognition with respect to input user speech, and outputs the result to the input interpreter 102, together with the recognition score of the candidate. If one candidate has a plurality of meanings, the speech recognition unit 101 outputs a plurality of candidates each including the candidate and a semantic tag indicating one of the plurality of meanings to the input interpreter 102, together with the recognition score of the candidate.

Referring to FIG. 22, “@genre” means “semantic tag given to content of user input is “genre””, and “φ” means “transition occurs even without user input”.

The degree of semantic conformance 711 indicates the degree to which an input content is required in a given dialog flow condition. For example, in the dialog scenario in FIG. 22, a link 702 which can instruct to change a search condition (“genre” in this case) also extends from a scenario node 701 which presents a search result. However, since the original purpose of the scenario node 701 is to sequentially trace scenario nodes by receiving the user inputs “next” and “previous”, the degree to which the search condition is required to be changed is not high. Therefore, the degree of semantic conformance of the link of the user inputs “next” and “previous” is “100”, but the degree of semantic conformance of the link 702 is “60”.

Although the dialog flow control processing in the dialog flow control unit 103 in the fifth embodiment is the same as that in the first embodiment, the contents of the dialog states stored in the dialog history storing unit 104 differ from those in the first embodiment.

A dialog state 750 in FIG. 23 includes a state ID 751 for identifying the dialog state, standby information 752 of each dialog state, contents 753 of variables, and information 754 for calculating a degree of state conformance. This dialog state differs from that shown in FIG. 4 in that the standby information 752 includes a degree of semantic conformance corresponding to the meaning of the content (character string) of each user input.

In step S205 in FIG. 2, when storing a dialog state in the dialog history storing unit 104, this system acquires a combination of the content of a user input from a link extending from the current scenario node and a degree of semantic conformance, and causes the dialog history storing unit 104 to store the combination as standby information in the dialog state.

The input interpreter 102 will be described next. The input interpreter 102 generates a plurality of input candidates, calculates the total score of each input candidate, and selects one of the plurality of input candidates on the basis of the total scores in the same manner as in the first embodiment. Note, however, that the input interpreter 102 in the fifth embodiment uses a degree of semantic conformance in addition to a speech recognition score and a degree of state conformance when calculating a total score. Assume that the fifth embodiment obtains a total score by adding these three measures.

The processing operation of the spoken dialog system will be described next by exemplifying a dialog scenario for a facility search service. The following will exemplify a case wherein a dialog is performed on the basis of a dialog scenario (FIG. 22) associated with search genre designation as part of the dialog for a facility search service.

### Fifth Dialog Example

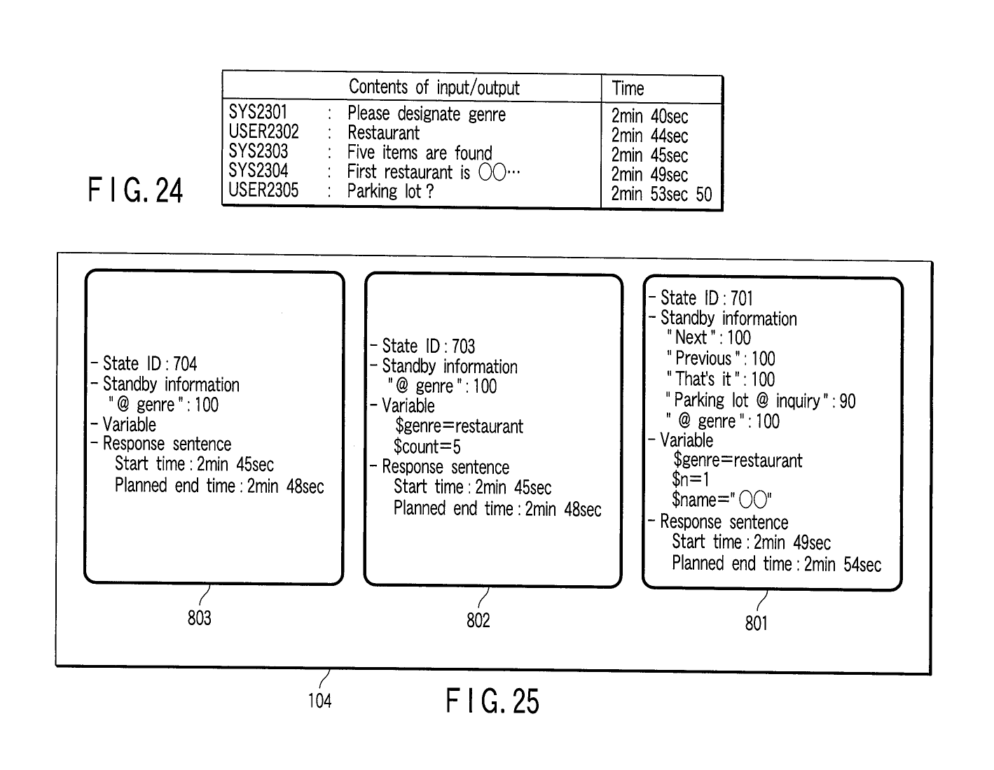

FIG. 24 shows a dialog example based on the dialog scenario in FIG. 22, in which the user designates “restaurant” as a search genre in a facility search service. A description of processing from “SYS2301” to “SYS2304” will be omitted, and input interpretation processing (steps S206 and S207 in FIG. 2) of the user input “USER2305” will be described.

As in the first embodiment, as shown in FIG. 25, the dialog history storing unit 104 sequentially stores a dialog state 803 when outputting the response “SYS2301”, a dialog state 802 when outputting the response “SYS2303”, and a dialog state 801 when outputting the response “SYS2304”. Therefore, at the time of the input of the user input “USER2305”, the dialog history storing unit 104 has been set in the state shown in FIG. 25.

The processing operations of the input interpreter 102 and a degree of state conformance calculation unit 106 with respect to the user input “USER2305” will be described next. “USER2305” is a user input intended to inquire whether the restaurant “◯◯” has a parking lot.

At 2 min 53 sec 50 msec, the user inputs the user input “USER2305”. When this system detects this user input, the process advances from step S204 to step S206.

When the user inputs a user input, the speech recognition unit 101 performs speech recognition processing with respect to the user input “USER2305”. Assume that [“parking lot” (1000 points)] could be obtained as a speech recognition result on “USER2305”. Assume that “parking lot” has two types of meanings, i.e., “genre” and “inquiry about presence/absence of parking lot”. In this case, as candidates of the user input contents, there are two candidates with the same speech recognition score, i.e., [“parking lot @ genre” (1000 points) and “parking lot @ inquiry” (1000 points)].

In step S206, the degree of state conformance calculation unit 106 calculates a degree of state conformance. A related information extraction unit 105 extracts the user input time “2 min 53 sec 50 msec”, and notifies the degree of state conformance calculation unit 106 of the extracted time. The degree of state conformance calculation unit 106 calculates a degree of state conformance SD(0) with respect to a current dialog state 801 by using equation (1), and also calculates a degree of state conformation SD(1) with respect to an immediately preceding dialog state 802 by using equation (2). Since the planned response time is five sec, and the response output time is 2 min 53 sec 50 msec−2 min 49 sec=4.5 sec, SD(0)=4.5/5×100=90 and SD(1)=100−90=10. The degree of state conformance calculation unit 106 notifies the input interpreter 102 of the degrees of state conformance with respect to these two dialog states.

Subsequently, in step S207 in FIG. 2, the input interpreter 102 performs input interpretation processing. The input interpreter 102 generates a plurality of combinations (input candidates) each including one candidate of a notified speech recognition result and one dialog state notified as a degree of state conformance calculation result, and calculates the total score of each combination.

Since there are two types of candidates of the input contents obtained as the speech recognition results, i.e., “parking lot @ genre” and “parking lot @ inquiry”, and there are two types of dialog state candidates on which the input contents are to act, i.e., the dialog states 801 and 802, the input interpreter 102 combines them to generate four types of input candidates, i.e., “parking lot @ genre” acts on dialog state 801, “parking lot @ inquiry” acts on dialog state 801, “parking lot @ genre” acts on dialog state 802, and “parking lot @ inquiry” acts on dialog state 802”.

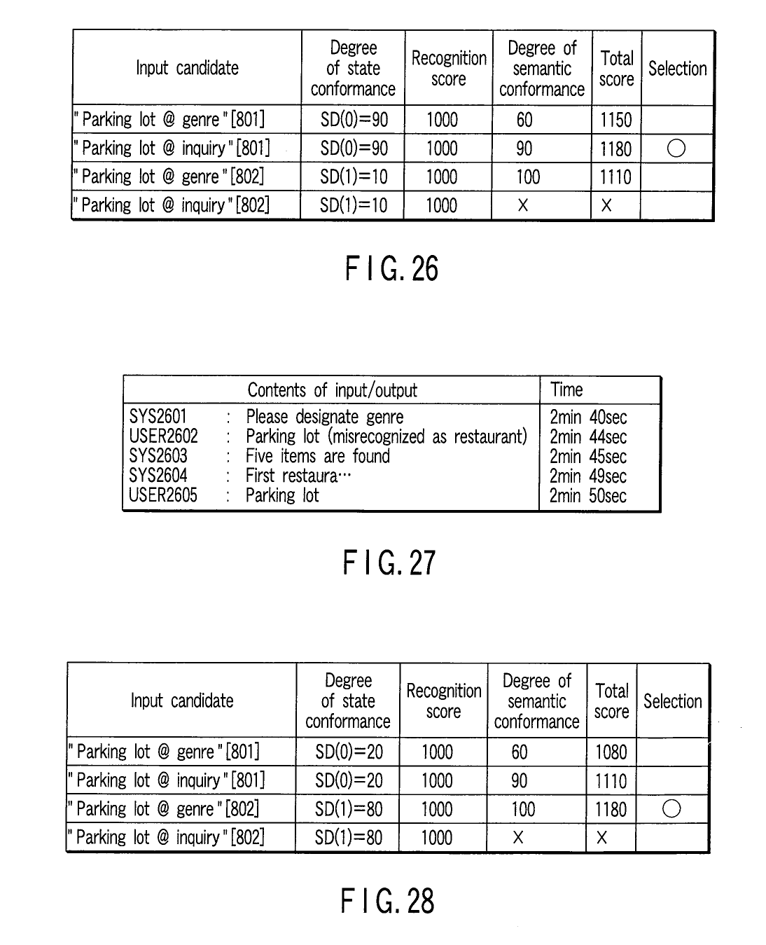

Subsequently, the input interpreter 102 calculates the total score of each input candidate. Total score calculation processing will be described with reference to FIG. 26. Since the standby information of each dialog state stored in the dialog history storing unit 104 includes a semantic tag and a degree of semantic conformance corresponding to the semantic tag, the input interpreter 102 extracts the degree of semantic conformance which is made to correspond to the semantic tag of an input content candidate in the dialog state in the input candidate. The input interpreter 102 then calculates the total score of each input candidate by adding the degree of state conformance, the recognition score, and the degree of semantic conformance.

The input interpreter 102 selects an input candidate with the highest total score as an input interpretation result. In this case, the input interpreter 102 selects the input candidate ““parking lot @ inquiry” acts on dialog state 801” as an input interpretation result. The input interpreter 102 notifies the dialog flow control unit 103 of this input interpretation result. In step S201 in FIG. 2, the dialog flow control unit 103 returns the check result on the presence/absence of the parking lot of the place “◯◯” to the user.

As described above, although a plurality of input candidates are derived from the same recognition result “parking lot”, the degree of semantic conformance with respect to an input content having the meaning of inquiry about the presence/absence of a parking lot is high in the dialog state 801 which presents the information of the first item of the search result. Therefore, “parking lot @ inquiry” is selected. In the immediately preceding dialog state 802, the degree of semantic conformance of “parking lot @ genre” is high, but the user speech “USER2305” has been input because a response which presents a search result has been completely output. Therefore, the degree of state conformance of the dialog state 801 which presents the information of the first item increases. This makes it possible to select “parking lot @ inquiry” from the sum of the degree of state conformance and the degree of semantic conformance.

### Sixth Dialog Example

The processing operations of the input interpreter 102 and degree of state conformance calculation unit 106 will be described next with reference to the dialog example in FIG. 27. According to the dialog example in FIG. 27, the user input “parking lot” of “USER2602” is misrecognized as “restaurant”, and the response “SYS2603” and the response “SYS2604” (the overall response indicates that “first restaurant is ◯◯”) are output. Therefore, the operation up to the output of “SYS2604” is the same as in the dialog example in FIG. 24. At this time, the dialog history storing unit 104 is in the state shown in FIG. 25.

Although the user has expected to receive a response with a content like “first parking lot is . . . ” as a response to the user input “USER2602”, he/she actually receives the response “SYS2604” with the content “first restaurant is . . . ”. According to the dialog example in FIG. 27, when the response is output up to “resta”, the user notices an error and inputs the user speech “USER2605”, i.e., “parking lot”, again at 2 min 50 sec.

When the user input “USER2605” is detected at 2 min 50 sec, the process advances from step S204 to step S206 in FIG. 2.

Upon receiving the user input, the speech recognition unit 101 performs speech recognition processing with respect to the user input “USER2605”. Assume that in this case, the speech recognition unit 101 obtains [“parking lot” (1000 points)] as a speech recognition result on “USER2605”, as in the case of “USER2305” in FIG. 24, and notifies the input interpreter 102 of [“parking lot @ genre” (1000 points) and “parking lot @ inquiry” (1000 points)” as input content candidates.

In step S206, the degree of state conformance calculation unit 106 calculates a degree of state conformance. The related information extraction unit 105 extracts the user input time “2 min 50 sec” and notifies the degree of state conformance calculation unit 106 of it. The degree of state conformance calculation unit 106 calculates the degree of state conformance SD(0) with respect to the current dialog state 801 by using equation (1), and also calculates the degree of state conformation SD(1) with respect to the immediately preceding dialog state 802 by using equation (2). Since the planned response time is five sec and the response output time is 2 min 50 sec−2 min 49 sec 1 sec, SD(0)=⅕×100=20 and SD(1)=100−20=80. The degree of state conformance calculation unit 106 notifies the input interpreter 102 of the degrees of state conformance with respect to these two dialog states.

Subsequently, in step S207 in FIG. 2, the input interpreter 102 performs input interpretation processing. The input interpreter 102 generates a plurality of combinations (input candidates) each including one candidate of a notified speech recognition result and one dialog state notified as a degree of state conformance calculation result, and calculates the total score of each combination.

Since there are two types of candidates of the input contents obtained as the speech recognition results, i.e., “parking lot @ genre” and “parking lot @ inquiry”, and there are two types of dialog state candidates on which the input contents are to act, i.e., the dialog states 801 and 802, the input interpreter 102 combines them to generate four types of input candidates, i.e., ““parking lot @ genre” acts on dialog state 801”, ““parking lot @ inquiry” acts on dialog state 801”, ““parking lot @ genre” acts on dialog state 802”, and ““parking lot @ inquiry” acts on dialog state 802”.

Subsequently, the input interpreter 102 calculates the total score of each input candidate. Total score calculation processing will be described with reference to FIG. 28. Since the standby information of each dialog state stored in the dialog history storing unit 104 includes a semantic tag and a degree of semantic conformance corresponding to the semantic tag, the input interpreter 102 extracts the degree of semantic conformance which is made to correspond to the semantic tag of an input content candidate in the dialog state in the input candidate. The input interpreter 102 then calculates the total score of each input candidate by adding the degree of state conformance, the recognition score, and the degree of semantic conformance.

The input interpreter 102 selects an input candidate with the highest total score as an input interpretation result. In this case, the input interpreter 102 selects the input candidate ““parking lot @ inquiry” acts on dialog state 801” as an input interpretation result. The input interpreter 102 notifies the dialog flow control unit 103 of this input interpretation result. In step S201 in FIG. 2, the dialog flow control unit 103 returns the current scenario node from the node 701 in FIG. 22 to the node 703 corresponding to the dialog state 802, and performs operation (a search for a parking lot in this case) to be performed when the input content “parking lot @ genre” in the input interpretation result is received in the dialog state 802. The dialog flow control unit 103 then returns a response which outputs the parking lot search result to the user.

As described above, a plurality of input candidates are derived from the same recognition result “parking lot”. However, upon noticing an error in the response output in the dialog state 801 which presents the search result, the user performs correction input, and hence the degree of state conformance of the immediately preceding dialog state 802 increases. In addition, since, in the dialog state 802, the input content “parking lot @ genre” has a semantic tag with a high degree of semantic conformance, the above input candidate which changes the search condition is selected. This makes it possible to smoothly change the search condition.

The fifth embodiment described above stores a history of dialog states which transit during a dialog with the user, and at the time of the input of user speech, calculates the degree of state conformance between the user input and each stored dialog state. In addition, the embodiment acquires the degree of semantic conformance of each dialog state with respect to the meaning of the content of the user input, and selects a content of the user input and a dialog state on which the user input is to act on the basis of the speech recognition score, degree of state conformance, and degree of semantic conformance. This makes it possible to easily and accurately correct the misinterpretation of the past user input by using a subsequent user input.

Note that in the above case, the calculation method for degrees of state conformance is based on the timing of a user input. However, the calculation method for degrees of state conformance is not limited to this. A measure like the power of input speech or the power of noise can be used as a degree of state conformance as described in the second and third embodiments.

In the above case, the dialog flow control unit 103 performs a dialog flow control method by referring to a dialog scenario described in a state transition chart. However, the dialog flow control method used by the dialog flow control unit 103 is not limited to this. That is, it is possible to use an arbitrary dialog flow control method as long as it can designate a degree of semantic conformance. For example, according to “RavenClaw: Dialog Management Using Hierarchical Task Decomposition and an Expectation Agenda” (D. Bohus et al., Eurospeech 2003), a dialog state is expressed by a stack of stack elements which can accept the contents of user inputs. This method preferentially searches for a stack element which can accept a user input from the top of the stack. According to such a scheme, it can be regarded that the degrees of semantic conformance of the stack elements sequentially decrease from the top of the stack. This makes it possible to dynamically calculate a degree of semantic conformance without designating a degree of semantic conformance in advance as in FIG. 22.

In the first to fifth embodiments, when the input interpreter 102 generates a plurality of combinations (input candidates) each including a candidate character string of a speech recognition result and a dialog state, the plurality of input candidates may include the same dialog state as that in a past dialog history and a speech recognition result candidate. In such a case, first of all, the input candidate including the same dialog state as that in the past dialog history and the speech recognition result candidate is deleted, and an input interpretation result is obtained from the remaining input candidates. In the case of the dialog example shown in FIG. 19 and the dialog history shown in FIG. 20, of the six types of input candidates shown in FIG. 21, ““next” acts on dialog state 601” and ““next” acts on dialog state 602” are input candidates existing in the past dialog history. Since these two input candidates amount to the repetition of the same operation as in the past dialog history, the two input candidates are deleted. Thereafter, the total scores of the remaining input candidates are calculated, and an input interpretation result is obtained.

The input interpreter 102 compares the degree of state conformance of each dialog state notified from the degree of state conformance calculation unit 106 with a predetermined threshold, and may delete any dialog state with a degree of state conformance lower than the threshold from candidates. Thereafter, the input interpreter 102 generates input candidates from the remaining dialog states and the character strings of speech recognition results, and obtains an input interpretation result in the same manner as described above. In this case, if the generated plurality of input candidates include input candidates existing in the past dialog history, it suffices to delete them and then obtain an input interpretation result in the above manner.

Letting the input interpreter 102 narrow down dialog states and input candidates in this manner makes it possible to speed up the processing.

The first to fifth embodiments each have exemplified the case wherein the spoken dialog system has a dialog with the user on the basis of a dialog scenario for restaurant search or facility search. Obviously, however, the spoken dialog system of each embodiment described above is not limited to the application of such search operation and can be applied to various applications, e.g., setting and operation for home electrical appliances such as a car navigation system, TV set, and video player.

It is possible to implement the techniques of the present invention described in the embodiments of the present invention, especially the functions of the speech recognition unit 101, input interpreter 102, dialog flow control unit 103, dialog history storing unit 104, related information extraction unit 105, degree of state conformance calculation unit 106, input condition extraction unit 111, and the like by causing a computer to implement programs. These programs can be distributed by being stored in recording media such as magnetic disks (flexible disks and hard disks), optical disks (CD-ROMs, DVDs, and the like), and semiconductor memories.

In the embodiments described above, for the sake of simplicity, input contents are candidate character strings of speech recognition. However, it suffices to use results obtained by additionally performing processing such as syntactic analysis/semantic analysis with respect to speech recognition results.

The spoken dialog system, according to the embodiments above, can easily and accurately correct false interpretation of a past user input by using a subsequent user input.

What is claimed is:

1. A spoken dialog system comprising:
a memory to store a history of dialog states;
a response output unit configured to output a system response in a current dialog state;
an input unit configured to input a user utterance;
a speech recognition unit configured to perform speech recognition of the user utterance, to obtain one or a plurality of recognition candidates of the user utterance and likelihoods thereof with respect to the user utterance;
a calculation unit configured to calculate a degree of state conformance of each of the current and the preceding dialog states stored in the memory with respect to the user utterance;
a selection unit configured to select one of the current and the preceding dialog states and one of the recognition candidates based on a combination of the degree of state conformance of each dialog state and the likelihood of each recognition candidate, to obtain a selected dialog state and a selected recognition candidate; and
a transition unit configured to perform transition from the current dialog state to a new dialog state based on the selected dialog state and the selected recognition candidate.

2. The system according to claim 1, further comprising:
a information acquisition unit configured to acquire information accompanying the user utterance; and wherein
the calculation unit calculates the degree of state conformance of each dialog state based on the information acquired by the information acquisition unit.

3. The system according to claim 2, wherein
the information acquisition unit acquires an input time of the user utterance, and
the calculation unit calculates the degree of state conformance of each dialog state based on a time from the instant the response output unit outputs the system response to the instant the user utterance is input.

4. The system according to claim 2, wherein
the information acquisition unit acquires information indicating a feeling of a user at the time of input of the user utterance, and
the calculation unit calculates the degree of state conformance of each dialog state based on the information indicating the feeling.

5. The system according to claim 1, further comprising:
a condition acquisition unit configured to acquire condition information, at the time of input of the user utterance, which influences a speech recognition result on the user utterance, and wherein
the calculation unit calculates the degree of state conformance of each dialog state based on the condition information.

6. The system according to claim 5, wherein the condition acquisition unit acquires a magnitude of noise at the time of input of the user utterance as the condition information.

7. The system according to claim 1, wherein
the memory stores, in correspondence with each dialog state in the history, a degree of current state conformance indicating the degree of state conformance with respect to a user utterance input when the response output unit outputs a system response in the dialog state, and
the calculation unit calculates the degree of state conformance of each dialog state based on the degree of current state conformance of each dialog state stored in the memory.

8. The system according to claim 1, wherein the selection unit selects the one of the current and the preceding dialog states and one of the recognition candidates based on a combination of the degree of state conformance of each dialog state, the likelihood of each recognition candidate, and a degree of semantic conformance indicating a degree of conformance of a meaning of each recognition candidate with respect to each dialog state.

9. A method for a spoken dialog system comprising:
storing, in a memory, a history of dialog states;
outputting a system response in a current dialog state;
inputting a user utterance;
performing speech recognition of the user utterance, to obtain one or a plurality of recognition candidates of the user utterance and likelihoods thereof with respect to the user utterance;
calculating a degree of state conformance of each of the current and the preceding dialog states stored in the memory with respect to the user utterance;
selecting one of the current and the preceding dialog states and one of the recognition candidates based on a combination of the degree of state conformance of each dialog state and the likelihood of each recognition candidate, to obtain a selected dialog state and a selected recognition candidate; and
performing transition from the current dialog state to a new dialog state based on the selected dialog state and the selected recognition candidate.

10. The method according to claim 9, further comprising:
acquiring information accompanying the user utterance; and wherein
calculating calculates the degree of state conformance of each dialog state based on the information acquired.

11. The method according to claim 10, wherein
acquiring the information acquires an input time of the user utterance, and
calculating calculates the degree of state conformance of each dialog state based on a time from the instant the system response is output to the instant the user utterance is input.

12. The method according to claim 10, wherein
acquiring the information acquires the information indicating a feeling of a user at the time of input of the user utterance, and
calculating calculates the degree of state conformance of each dialog state based on the information indicating the feeling.

13. The method according to claim 9, further comprising:
acquiring condition information, at the time of input of the user utterance, which influences a speech recognition result on the user utterance, and wherein
calculating calculates the degree of state conformance of each dialog state based on the condition information.

14. The method according to claim 13, wherein the acquiring the condition information acquires a magnitude of noise at the time of input of the user utterance as the condition information.

15. The method according to claim 9, wherein
storing stores, in the memory, in correspondence with each dialog state in the history, a degree of current state conformance indicating the degree of state conformance with respect to a user utterance input when the system response in the dialog state is output, and
calculating calculates the degree of state conformance of each dialog state based on the degree of current state conformance of each dialog state stored in the memory.

16. The method according to claim 9, wherein selecting selects the one of the current and the preceding dialog states and one of the recognition candidates based on a combination of the degree of state conformance of each dialog state, the likelihood of each recognition candidate, and a degree of semantic conformance indicating a degree of conformance of a meaning of each recognition candidate with respect to each dialog state.

17. A computer readable storage medium storing instructions of a computer program which when executed by a computer results in performance of steps comprising:
storing, in a memory, a history of dialog states;
outputting a system response in a current dialog state;
inputting a user utterance;
performing speech recognition of the user utterance, to obtain one or a plurality of recognition candidates of the user utterance and likelihoods thereof with respect to the user utterance;
calculating a degree of state conformance of each of the current and the preceding dialog states stored in the memory with respect to the user utterance;
selecting one of the current and the preceding dialog states and one of the recognition candidates based on a combination of the degree of state conformance of each dialog state and the likelihood of each recognition candidate, to obtain a selected dialog state and a selected recognition candidate; and
performing transition from the current dialog state to a new dialog state based on the selected dialog state and the selected recognition candidate.
